(19) United States
(12) Patent Application Publication
(10) Pub. No.: US 2013/0346363 A1
(43) Pub. Date: Dec. 26, 2013

(54) DATA SYNCHRONIZATION METHOD, COMPUTER READABLE RECORDING MEDIUM HAVING STORED THEREIN DATA SYNCHRONIZATION PROGRAM, AND DATA SYNCHRONIZATION CONTROL DEVICE

(71) Applicant: FUJITSU LIMITED, KAWASAKI-SHI (JP)

(72) Inventors: Takahiro ARAKAWA, Machida (JP); Takashi Matsuda, Kawasaki (JP)

(73) Assignee: FUJITSU LIMITED, KAWASAKI-SHI (JP)

(21) Appl. No.: 13/961,937

(22) Filed: Aug. 8, 2013

Related U.S. Application Data
(63) Continuation of application No. PCT/JP2011/052758, filed on Feb. 9, 2011.

(51) Int. Cl. G06F 17/30

(52) U.S. Cl. CPC G06F 17/30575
USPC 707/610

(57) ABSTRACT

Disclosed is a data synchronization method which includes acquiring first update data for an update process performed on a first database, converting the first update data into second update data according to a format of a second database based on a previously set conversion definition information, deciding a lock range based on the first update data and the pre-update data that has not been subjected to the update process, locking the first and second databases based on the decided lock range, and updating the first and second databases using the first and second update data, respectively.

### CROSS-REFERENCE TO RELATED APPLICATION

This application is a continuation application of International Application PCT/JP2011/052758 filed on Feb. 9, 2011 and designated the U.S., the entire contents of which are incorporated herein by reference.

### FIELD

The present disclosure relates to a data synchronization method, a computer readable recording medium having stored therein a data synchronization program, and a data synchronization control device.

### BACKGROUND

Information processing systems configured with one or more information processing apparatuses such as enterprise systems or systems providing various kinds of services, various databases are used according to a situation in order to collect and manage information to be dealt.

Examples of a database include an SQL based database such as Oracle (a registered trademark), SQL Server (a registered trademark), MySQL, and PostgreSQL, and a read/write interface database such as SymfoWARE (a registered trademark), PowerRW+, and Pervasive.SQL (a registered trademark).

Ideally, when two or more databases are used in a system, the databases preferably include the same structure (type), for example, an terms of synchronization between databases. However, the are cases in which databases of different types including different data structures are used together, for example, in the following situations.

(a) A case in which in business integration or the like, databases including different structures which have been used for different types of business continue to be individually used in a state in which consistency of only data is made.

(b) A case in which databases including different structures continue to be used in parallel as a transitory measure in preparation for future integration into a database of a single structure (type).

(c) A case in which a license fee of a database in use is high, and an inexpensive database including a different structure (type) from a database in use is employed as a database newly introduced in parallel.

(d) A case in which functions of databases are different, and it is difficult to integrate the databases into a database of a single type.

In the cases (a) to (d), for example, any one of first to third techniques illustrated in FIGS. 17 to 19 can be used in order to synchronize data of databases including different structures with each other.

The following description will proceed with an example in which data of a first database management system (DBMS) 111 is synchronized with data of a second DBMS 121 when a first virtual operating system (OS) 110 including the first DBMS 111 and a second virtual OS 120 including the second DBMS 121 are executed in a virtual machine 100.

FIG. 17 is a diagram illustrating a first technique in which an application 113 of the first virtual OS 110 accesses a database of the second virtual OS 120 and performs data synchronization, and FIG. 18 is a diagram illustrating is second technique in which data synchronization is performed by a trigger function of a database. FIG. 19 is a diagram illustrating a third technique in which data synchronization is performed by a replication function of a database.

Here, as illustrated in FIGS. 17 to 19, the virtual machine 100 operates on an information processing system, and executes the first virtual OS 110 and the second virtual OS 120. The virtual machine 100 manages allocation of resources such as a central processing unit (CPU) or a memory of the information processing system to the first virtual OS 110 and the second virtual OS 120.

For example, a hypervisor may be used as the virtual machine 100.

The first virtual OS 110 includes the first DBMS 111 and a communication unit 112, and the second virtual OS 120 includes the second DBMS 121 and a communication unit 122. The first DBMS 111 and the second. DBMS 121 are databases managed by the first virtual OS 110 and the second virtual OS 120, respectively. In this example, the first DBMS 111 and the second DBMS 121 are different in a database type and a data structure.

The first virtual OS 110 is able to perform communication with the second virtual OS 120 via a network through the communication units 112 and 122.

A technique of synchronizing data between the first DBMS 111 and the second DBMS 121 when the first DBMS 111 is updated by the application 113 or 114 will be described below with reference to FIGS. 17 to 19.

FIG. 17 illustrates an example of the first technique in which all programs accessing a database are changed such that data of databases including different structures can be automatically synchronized.

For example, when the application 113 executed on the first virtual OS 110 accesses only the first DBMS 111, the application 113 is changed to be able to access both of the first DBMS 111 and the second DBMS 121.

As the application 113 is changed, synchronization of data with the second DBMS 121 is performed by the application 113 in the order of (1) to (4) illustrated in FIG. 17.

In other words, the application 113 makes a change on the first DBMS 111 (1), and outputs changed data to the communication unit 112 (2). The communication unit 112 transmits the data input from the application 113 to the communication unit 122 of the second virtual OS 120 via a network (3). Finally, the communication unit 122 reflects (updates) the data received from the communication unit 112 in the second DBMS 121 (4), and completes the data synchronization process in the virtual machine 100.

Note that, the data input to the communication unit 112 in (2) illustrated in FIG. 17 is data which has been subjected to conversion from data corresponding to a format of the first DBMS 111 to data corresponding to a format of the second DBMS 121 by the application 113.

In the second technique, as illustrated in FIG. 18, for data synchronization between databases including different structure, synchronization is performed such that data matching with a counterpart database is performed using a trigger function of a database.

The trigger function refers to a function of executing predetermined processing using certain action on a database such as an update operation as a trigger.

In the virtual machine 100, synchronization of data with the second DBMS 121 is performed in the order of (1) to (10) illustrated in FIG. 18 using a trigger function 115.

In other words, when the application 114 makes a change on the first DBMS 111 (1), the first DBMS 111 activates the trigger function 115 (2). Then, the trigger function 115 inputs toe changed data to a data 116 (3). The data converting unit 116 converts data corresponding to a format of the first DBMS 111 into network communication data, and outputs the converted data to the communication unit 112 (4).

Next, the communication unit 112 transmits the input data to the communication unit 122 of the second virtual OS 120 via a network (5), and the communication unit 122 outputs data received from the communication unit 112 to a data converting unit 126 (6). Then, the data converting unit 126 converts the input network communication data into data corresponding to a format of the second DBMS 121, and reflects (updates) the converted data in the second DBMS 121 (7).

When the update of the second. DBMS 121 is completed, the communication unit 122 transmits an update completion notification to the communication unit 112 of the first virtual OS 110 is the network (8). The update completion notification passes through the communication unit 112 and the trigger function 115 (9), and then is given to the application 114 (10), and the data synchronization process in the virtual machine 100 is completed.

In the third technique, as illustrated in FIG. 19, for data synchronization between databases including different structures, data synchronization is performed using a replication function of a database.

The replication function refers to a function of updating a database at another site by accumulatively storing update data or an operation performed on a single database and transmitting accumulated update data or like to another site at regular time intervals or at a certain timing when a predetermined amount of update data is accumulated.

In the virtual machine 100, data synchronization with the second DBMS 121 is performed by the replication function in the order of (1) to (6) illustrated in FIG. 19.

In other words, when the application 114 makes a change on the first DBMS 111 (1), the first DBMS accumulates update data or an operation related to the updating (2), and notifies the application 114 of the fact that the update of its own database has been completed (3). Next, the data synchronizing unit 118 outputs accumulated update data 117 to the communication unit 112 at regular time intervals or at a certain timing when a certain amount of update data is accumulated (4).

Then, the communication unit 112 transmits the input update data 117 to the communication unit 122 of the second virtual OS 120 via the network (5). Finally, the communication unit 122 reflects (updates) the data received from the communication unit 112 in the second DBMS. 121 through a conversion process or the like a data synchronizing unit 128 (6), and thus the data synchronization process in the virtual machine 100 is completed.

Here, accumulated update data 117 is illustrated in FIG. 19. The data synchronizing units 118 and 128 perform the replication function execution process.

In the second and third technique, communication between the communication units 112 and 122 is often performed via a network. Thus, the fir at virtual OS 110 and the second virtual OS 120 may be executed using resources of different information processing apparatuses.

Note that, as a technique of synchronizing data between databases including the same structure, for example, a technique in which a shared buffer for respective DBMSs is arranged in a shared memory accessible from two electronic computers has been known.
[Patent Literature 1] Japanese Laid-open Patent Publication. No. 5-313985
[Patent Literature 2] Japanese Laid-open Patent Publication No. 8-95841
[Patent Literature 3] Japanese Laid-open Patent Publication No. 11-306061
[Patent Literature 4] Japanese Laid-open Patent Publication No. 2009-15.534

The above-described first to third data synchronization techniques include the following problems.

(i) In the first technique, since a change is made on all programs accessing a database, many man-hours are required in changing the programs. Further, maintainability of a program deteriorates, and subsequent maintenance man-hours increase.

(ii) In the second technique, update data is often reflected in an update target database via a network at the time of data update. Data synchronization with an update target database, for example, the second DBMS 121 via the network takes a long time compared to data updating performed on an update source database, for example, the first DBMS 111 via a data bus. Thus, in both databases, a period of time in which it is difficult to access a data lock section, that is, a period of time in which a lock section is locked increases, and a shared degree of a database deteriorates.

Note that, the database lock refers to exclusive control of preventing other applications or the like from accessing an update target range when data of a database is updated, and the lock section refers to an update target range such as rows.

(iii) In the third technique, when DBMS provision sources or types are different, the replication functions are different, and thus it may be difficult to use the replication function for data synchronization between databases. Further, since data synchronization is performed such that updating on an update target database (for example, the second DBMS 121) is performed with a delay after updating on an update source database (for example, the first DBMS 111), there are cases in which updated data have not been reflected even when the system user refers to the update target database after data updating on the source database.

(iv) In the second and third techniques, both the trigger function and the replication function perform data synchronization with the update target database via the network, a data leak is likely to occur. Further, when the network is temporarily disable, it is difficult to perform data synchronization, and when data synchronization is performed after a network recovery, there is a problem in that access to the network is concentrated, and a network load significantly increases.

(v) Further, at the time of data synchronization, for example, due to the problems described in (v-i) and (v-ii), there is a demand for a technique of improving a shared degree of a database.

(v-i) When data synchronization with update target databases including different structures is performed on data updated in an update source database, a lock section increases compared to when a lock section is set to one database when an attempt to unify lock sections at a plurality of databases is made.

For example, when a lock section of an update source database corresponds to one row in a table, a lock section to be set to an update target database is set to include all columns of the lock section of the date source database. Since the update source database is different in the structure from the update target database, there are cases in which items included in the lock section of the update source database are dispersedly arranged in a plurality of tables of the update target database. At this time, in the update target database, since update target rows in a plurality of tables are set to the lock section, the lock section increases.

(vii) For improvement in security, there are cases in which only a necessary column is referred to by a view without directly referring to a table of a database. When a certain column in a table is referred to by a view, for example, if a column not referred to by a view is updated by another application or the like, an updated row is locked, and thus there is a problem in that it is difficult to access via a view.

### SUMMARY

According to an aspect of the embodiment, a data synchronization method according to the present disclosure includes acquiring first update data for an update process performed on a first database, converting the first update data into second update data according to a format of a second database based on previously set conversion definition information, deciding a lock range based on the first update data and pre-update data before the update process is performed, locking the first and second databases based on the decided lock range, and updating the first and second databases using the first and second update, data respectively.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of virtual machine according to the present exemplary embodiment.

FIG. 2 is a diagram for describing a data synchronization process of a virtual machine according to the present exemplary embodiment.

FIG. 3 is a diagram illustrating an exemplary configuration of a conversion definition file according to the present exemplary embodiment.

FIG. 4 is a diagram illustrating an internal expression format of numerical data in a database according to the present exemplary embodiment.

FIG. 5 is a diagram for describing a data conversion process performed by a data conversion processing unit according to the present exemplary embodiment.

FIG. 6 is a diagram illustrating an exemplary configuration of a lock management table according to the present exemplary embodiment.

FIG. 7 is a diagram for describing a column pattern in a lock management table according to the present exemplary embodiment.

FIG. 8 is a sequence diagram for describing a data synchronization process performed by a virtual machine according to the present exemplary embodiment.

FIG. 9 is a flowchart for describing a process of a data update unit according to the present exemplary embodiment.

FIG. 10 is a flowchart for describing data conversion and lock acquisition processes of an update data control unit according to the present exemplary embodiment.

FIG. 11 is a flowchart for describing a data conversion process of a data conversion processing unit according to the present exemplary embodiment.

FIG. 12 is a flowchart for describing a lock range decision process of a lock granularity determination processing unit according to the present exemplary embodiment.

FIG. 13 is a flowchart for describing a lock acquisition process of a lock control processing unit according to the present exemplary embodiment.

FIG. 14 is a flowchart for describing a lock release process of en update data control unit according to the present exemplary embodiment.

FIG. 15 is a flowchart for describing a lock release process of a lock control processing unit according to the present exemplary embodiment.

FIG. 16 is a flowchart for describing a process of an asynchronous reflecting unit according to the present exemplary embodiment.

FIG. 17 is a diagram illustrating a first technique as an example of a data synchronization technique according to a related art.

FIG. 18 is a diagram illustrating a second technique as an example of a data synchronization technique according to a related art.

FIG. 19 is a diagram illustrating a third technique as an example of a data synchronization technique according to a related art.

### DESCRIPTION OF EMBODIMENTS

Hereinafter, exemplary embodiments of the present invention will be described with reference to the accompanying drawings.

### [1] Embodiment

### [1-1] Configuration of Embodiment

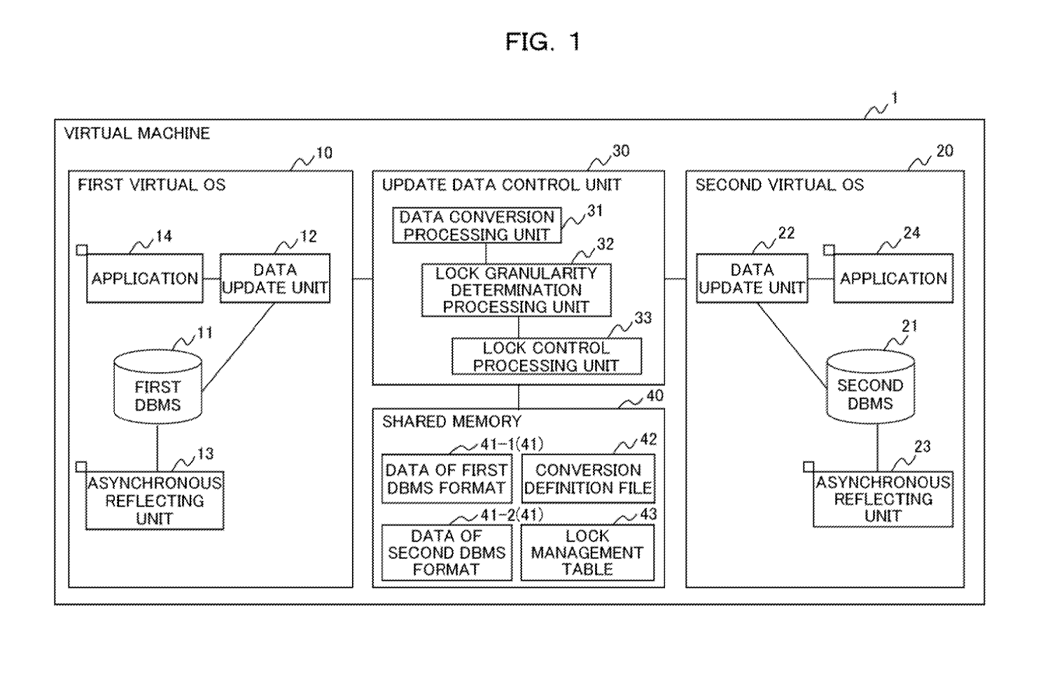

FIG. 1 is a diagram illustrating an exemplary configuration of a virtual machine 1 according to the present exemplary embodiment.

The virtual machine 1 is a virtual computer including no actual hardware configuration, and executes a plurality of virtual OSs on the virtual machine 1 and manages, for example, allocation of various resources to a plurality of virtual OSs. For example, a hypervisor may be used as the virtual machine 1.

Note that, in the present embodiment, the virtual machine 1 operates on an information processing system including one or more information processing apparatuses, and uses resources such as a CPU or a memory of the information processing system.

In the present embodiment, the virtual machine 1 includes and executes a first virtual OS 10, a second virtual OS 20, and an update data control unit 30, and uses a part of the memory of the information processing system as a shared memory 40. Further, the virtual machine 1 manages allocation of resources of the information processing system to the first virtual OS 10, the second virtual OS 20, and the update data control unit 30.

Each of the first virtual OS 10 and the second virtual OS 20 can access hardware or an individual memory of the information processing apparatus through the kernel provided by the virtual machine 1.

The first virtual OS 10, includes a first DBMS 11, a data update unit 12, an asynchronous reflecting unit 13, and an application 14. The second virtual OS 20 includes a second DBMS 21, a data update unit 22, an asynchronous reflecting unit 23, and an application 24.

The first DBMS 11 and the second Dams 21 are databases managed by the first virtual OS 10 and the second virtual OS 20, respectively. In the present embodiment, the first DBMS 11 and the second DBMS 21 are databases of different types and include different data structures. Note that, the first DBMS 11 and the second DBMS 21 manage data the form of a matrix. When data in the database is updated, an update target row is designated, and an update target region in the designated row is updated.

The virtual machine 1 performs data synchronisation on the first DBMS 11 and the second DBMS 21 respectively managed by the first virtual OS 10 and the second virtual OS 20 by a technique which will be described later.

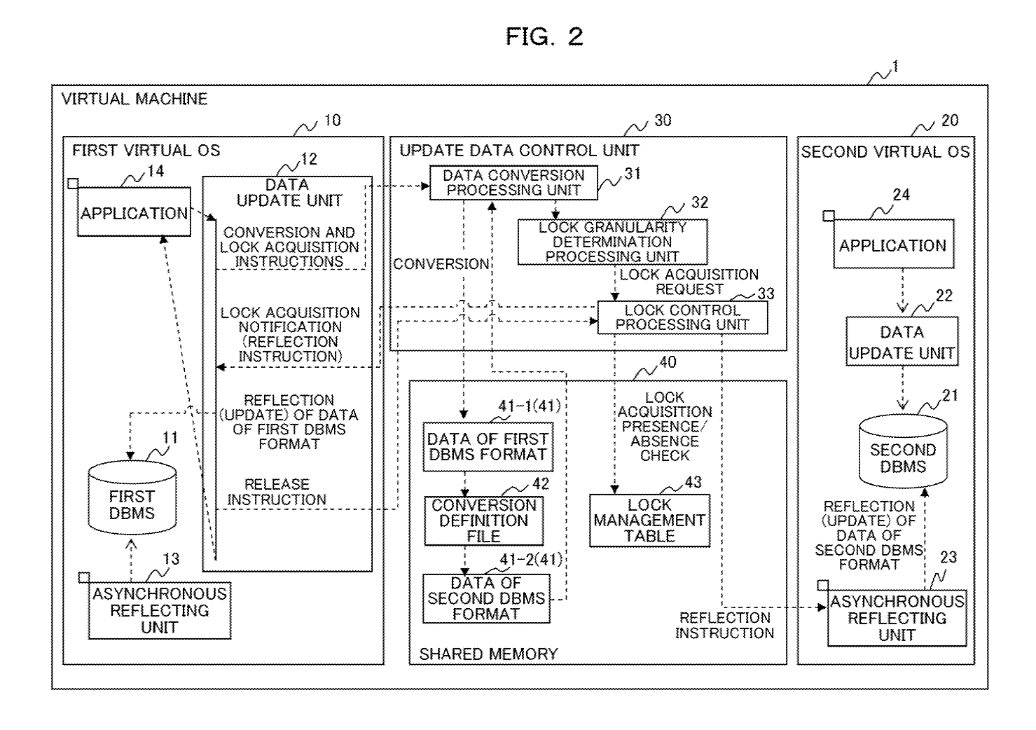

FIG. 2 is a diagram for describing a data synchronization process performed by the virtual machine 1 according to the present exemplary embodiment. In the example illustrated in FIG. 2, the data synchronisation process between the first DBMS 11 and the second DBMS 12 performed by the virtual machine 1 will be described in connection with an example in which the application 14 of the first virtual OS 10 updates the first DBMS 11.

The application 14 is an arbitrary application operating on the first virtual OS 10, and accesses the first DBMS 11, for example, in order to change or refer to data.

Further, when updating such as a change, addition, or deletion of data is performed on the first DBMS 11, the application 14 outputs an update processing request (update request) to the data update unit 12.

Upon receiving the database update processing request from the application 14, the data update unit 12 performs data updating on the first DBMS 11. In other words, the data update unit 12 is called from the application 14 when the first DBMS 11 is updated, and the application 14 updates the first DBMS 11 through the data update unit 12.

Here, the data update unit 12 updates the first DBMS 11 at the sane time as a timing at which the second DBMS 21 is updated in order to synchronize data between the first DBMS 11 and the second DBMS 21.

Specifically, upon receiving the database update processing request from the application 14, the data update unit 12 acquires pre-update data and update data (first update data) 41-1 from a memory accessible from the application 14.

Here, the pre-update data is data before the update to the data which has been subjected to the update process performed on the first DBMS 11. The update data 41-1 is data (updated data) which has been subjected to the update process performed on the first DBMS and has a format (first DBMS format) corresponding to the data structure of the first DBMS 11.

Then, the data update unit 12 generates update difference data based on the acquired pre-update data and the update data 41 and outputs the update difference data and the update data 41-1 to the update data control unit 30 together with a conversion instruction and a lock acquisition instruction which will be described later.

For example, the generation of the update difference data by the data update unit 12 is performed by comparing the pre-update data with the updated data 41-1 and extracting information of a portion to be updated (for example, a column to be updated). The generated update difference data includes information representing a portion to be updated. Note that, the update difference data may further includes update data of a portion to be updated.

Note that, the update difference data output from the data update unit 12 may be data itself or may be information specifying the update difference data such as an address of a location in which the data is stored. Hereinafter, the data and the information are collectively referred to simply as “update difference data.”

Similarly, the update data 41-1 output from the data update unit 12 may be data itself or may be information specifying the update data 41-1 such as an address of a location in which the data is stored. Hereinafter, the data and the information are collectively referred to simply as “update data 41-1.”

In other words, instead of or after outputting the update difference data and the update data 41-1 to the data update unit 12, for example, the data update unit 12 may store the update difference data and the update data 41-1 in the shared memory 40 which will be described later and output an address in which the data is stored.

Hereinafter, the data update unit 12 or 22 that has output the conversion instruction and the lock acquisition instruction to the update data control unit 30 is referred to as a data update unit 12 or 22 of a request source (instruction source) or simply as a request source (instruction source).

The update data control unit 30 converts the update data 41-1 of the request source into update data (second update data) 41-2 including a second DBMS format nor responding to a format of the second DBMS 21 which is a data synchronization target other than the request source. Further, the update data control unit 30 decides a database lock range as will be described later, locks the first DBMS 11 and the second DBMS 21, and outputs a lock acquisition notification (reflection instruction) to the data update unit 12 which is the request source.

Upon receiving the lock acquisition notification (reflection instruction) of the first DBMS 11 and the second DBMS 21 from the update data control unit 30, the data update unit 12 updates the first DBMS 11. Further, the data update unit 12 outputs a lock release instruction of the first DBMS 11 and the second DBMS 21 which are locked to the update data control unit 30.

As described above, the lock acquisition instruction and the lock release instruction of the first DBMS 11 and the second DBMS 21 which are data synchronization target databases are issued by the data synchronization request source, that is, the data update unit 12 of the virtual OS 10 in the example illustrated in FIG. 2.

When another virtual OS such as the second virtual OS 20 functions as the request source, and data synchronisation is performed, the asynchronous reflecting unit 13 reflects (updates) the update data 41-1 of the first DBMS format in the first DBMS 11.

In other words, the asynchronous reflecting unit 13 operates according to the database update processing request from another virtual OS when the reflection instruction and the update data 41-1 of the first DBMS format converted from update data of the DBMS format of another virtual. OS are input from the update data control unit 30. The processing performed by the asynchronous reflecting unit 13 is performed in out of synchronisation with the data update unit 12 or the application 14.

Note that, the asynchronous reflecting unit 13 may receive the address of the update data 41-1 stored in the shared memory 40 from the update data control unit 30. In this case, the asynchronous reflecting unit 13 accesses the received address and acquires the update data 41-1.

Hereinafter, as reference numerals representing update data, reference numerals 41-1 and 41-2 are used when it is necessary to include one of the update data 41-1 and 41-2, reference numeral 41 is used but when arbitrary update data is represented. Note that, the update data 41 includes data output from the data update unit 12 or 22, that is update data of the request source, and data converted by the update data control unit 30, that is, update data converted into a DBMS format of a synchronization target other than the request source as described above.

Note that, in the example illustrated in FIG. 2, since the first virtual OS 10 functions as the request source and data synchronisation is performed, processing by the asynchronous reflecting unit 13 is not performed.

The data update unit 22, the asynchronous reflecting unit 23, and the application 24 include the same functions as the data update unit 12, the asynchronous reflecting unit 13, and the application 14, respectively.

In other words, the application 24 is en arbitrary application operating on the second virtual OS 20, and accesses the second DBMS 21, for example, in order to change or refer to data.

Further, when updating such as a change, addition, or deletion of data is performed on the second DBMS 21, the application 24 outputs an update processing request (update request) to the data update unit 12.

Similarly to the data update unit 12, upon receiving the update processing request of the second DBMS 21 from the application 24, the data update unit 22 acquires the pre-update data and the update data 41-2 for the update process. Then, the data update unit 22 generates the update difference data based on the pre-update data and the update data 41-2, and outputs the update data 41-2 and the update difference data to the update data control unit 130 together with the conversion instruction and the lock acquisition instruction.

Further, upon receiving the reflection instruction from the update data control unit 30, the data update unit 22 updates the second DBMS 21, and outputs the lock release instruction to the update data control unit 30.

The asynchronous reflecting unit 23 operates according to the database update processing request from another virtual OS (the first virtual OS 10 in FIG. 2) when the reflection instruction and the update data 41-2 of the second DBMS format converted from update data of the DBMS format of another virtual OS are input from the update data control unit 30.

In other words, in the example illustrated in FIG. 2, the asynchronous reflecting unit 23 of the second virtual OS 20 different form the first virtual OS 10 serving as the data synchronization request source reflects (updates) the update data 41-2 in the second DBMS 21 based on the reflection instruction from the update data control unit 30.

In other words, the asynchronous reflecting unit 23 of the second virtual OS 20 operates when another virtual OS (the first virtual OS 10) functions as the request source and data synchronization is performed. At this time, upon receiving the update data 41-2 of the second DBMS format and the reflection instruction from the update data control unit 30, the asynchronous reflecting unit 23 reflects the update data 41-2 in the second DBMS 21.

Note that, as described above, the asynchronous reflecting unit 23 may receive the address of the update data 41-2 stored in the shared memory 40 from the update data control unit 30, and in this case, the asynchronous reflecting unit 23 accesses the received address and acquires the update data 41-2.

The reflection instruction on the asynchronous reflecting unit 23 is output from the update data control unit 30 at the same time or at approximately the same time as the reflection instruction on the data update unit 12.

Note that, when the application 24 of the second virtual OS 20 updates the second DBMS 21, the data synchronization process by the virtual machine 1 can be implemented by switching between the first virtual OS 10 and the second virtual OS 20 as described above with reference to FIG. 2.

Note that, as described above, the application and the data update unit in the virtual OS other than the data synchronization request source enters a standby status for an instruction without performing processing associated with data synchronization by the request source. In other words, in the example illustrated in FIG. 2, the application 24 of the second virtual OS 20 and the data update unit 22 different from the first virtual OS 10 serving as the data synchronisation request source enters a standby status for an instruction without performing processing associated with data synchronization by the first virtual OS 10.

Meanwhile, as described above, the asynchronous reflecting unit in the virtual OS of the data synchronisation request source enters a standby status for an instruction without performing processing associated with data synchronization by the request source. In other words, in the example illustrated in FIG. 2, since the first virtual OS 10 functions as the request source and data synchronisation is performed, a standby status for an instruction is invoked without performing processing by the asynchronous reflecting unit 13.

The update data control unit 30 is arranged in the virtual machine 1, and is accessed from the data update units 12 and 22 of a plurality of virtual OSs, that is, the first virtual OS 10 and the second virtual OS 20. The update data control unit 30 performs processing according to the request input from the data update unit 12 or 22, and notifies the data update units 12 or 22 of the result.

The update data control unit 30 includes a data conversion processing unit 31, a lock granularity determination processing unit 32, and a lock control processing unit 33.

Upon receiving the conversion instruction and the update data 41 from the data update unit 12 or 22 of the request source, the data conversion processing unit 31 performs data conversion on the update data 41 based on a conversion definition file 42 which is defined in advance.

In other words, the data conversion processing unit 31 performs a process of converting the update data 41 corresponding to a DBMS format of the request source into the update data 41 corresponding formats of all DBMS excluding the DBMS of the request source based on the previously set conversion definition file 42.

In the example illustrated in FIG. 2, the data conversion processing unit 31 performs a process of converting the first update data 41-1 corresponding to the format of the first DBMS 11 into the second update data (converted data) 41-2 corresponding to the format of the second DBMS 21.

Further, the date conversion processing unit 31 stores the update data 41 input from the data update unit 12 or 22 of the request source and the update data 41 converted by the data conversion processing unit 31 in the shared memory 40. Note that, when the update data 41 of the request source is stored in the shared memory 40 by the data update unit 12 or 22 of the request source as described above, the data conversion processing unit 31 may store only the converted update data 41 in the shared memory 40.

Note that, notification of the conversion result by the data conversion processing unit 31 is given to the data update unit 12 or 22 of the conversion instruction request source.

Further, when data conversion is completed, the data conversion processing unit 31 generates a lock key (which will be described later) representing a row including the update data 41 in a table in a database based on the update data 41.

The lock granularity determination processing unit 32 decides lock granularity (lock range) used to lock a region of an update target database.

Note that, the lock granularity (lock range) refers to a range in which exclusive control is performed when data of a database is updated. In the present embodiment, the lock granularity determination processing unit 32 decides the lock range using a column of a table in the first DBMS 11 and the second DBMS 21 as a minimum unit. In other words, the lock range is a range including all of one or more columns to be undated among columns in an update target row related to an update process.

Specifically, the lock granularity determination processing unit 32 decides the lock range based on the pre-update data of the request source and the update data 41. In other words, the lock granularity determination processing unit 32 determines a range to be updated by the update process based on the update difference data generated based on the pre-update data and the updated data 41, and decides the range as the lock range.

In the example illustrated in FIG. 2, the lock granularity determination processing unit 32 decides the lock range based on the update difference data generated based on the pre-update data and the updated data 41-1.

Since the update difference data includes information representing a portion (column) to be updated as described above, the lock granularity determination processing unit 32 decides a column (item) to be updated in the first DBMS 11 and the second DBMS 21 based on the information representing the portion to be updated.

Then, the lock granularity determination processing unit 32 decides a range including all columns (items) determined to be updated as the lock range.

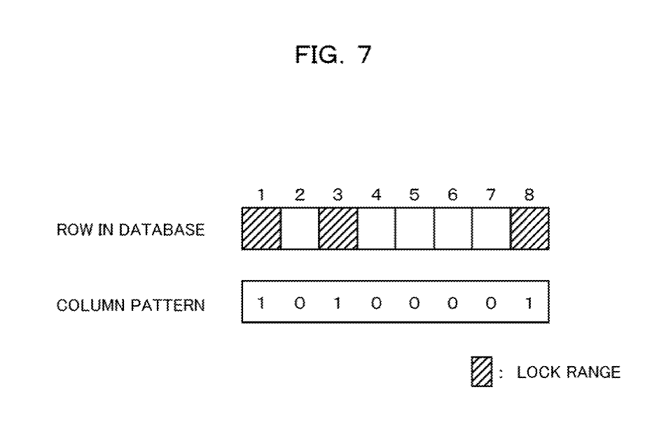

Here, the lock range generated by the lock granularity determination processing unit 32 is represented, for example, by a column pattern illustrated in FIG. 7.

The column pattern is a bit string in which a target column to be locked by the lock control processing unit 33 which will be described later is “1” and a non-target column is “0.”

For example, as illustrated in FIG. 7, when a single row in a database includes 8 columns and first, third, and eighth columns are decided as the lock range by the lock granularity determination processing unit 32, a column pattern is “10100001.”

As the lock range represented by the column pattern illustrated in FIG. 7 is locked by the update data control unit 30, the first DBMS 11 and the second DBMS 21 perform the exclusive control only on the columns to be updated by the update data 41 among the columns in the update target row.

In other words, the exclusive control is performed in units of rows in the related art, but since the lock granularity determination processing unit 32 decides the lock range using a column as a minimum unit, the exclusive control can be performed in units of regions specified by the update target row and a single column in the lock range. Thus, a column within a range not to be updated in the update target row is not subjected to the exclusive control, and thus a shared degree of a database can be improved.

Hereinafter, a region specified by an update target row and a single column in a lock range is referred to as a “block.” In other words, in the present embodiment, the lock range is decided in units of 1 (row)×1 (column) blocks in the database, and a region which is to be subjected to the exclusive control can be specified by one or more blocks.

The lock control processing unit 33 locks the first DBMS 11 and the second DBMS 21 serving as the data synchronization target based on the lock acquisition instruction input by the data update unit 12 or 22 of the request source and the lock granularity decided by the lock granularity determination processing unit 32.

Specifically, the lock control processing unit 33 checks a lock status of the lock range of the update target in a lock management table 43 which will be described later based on the lock acquisition instruction and the update data 41 input from the data update unit 12 or 22 and the lock range decided by the lock granularity determination processing unit 32.

The lock management table 43 stores a lock key representing a row including the update date 41 in a table in a database. The lock control processing unit 33 checks whether the lock range of the update target decided by the lock granularity determination processing unit 32 can be locked or has been already locked based on the lock key stored in the lock management table 43 and the lock range.

Note that, a concrete process of checking the lock status of the lock range of the update target through the lock control processing unit 33 will be described later.

When the lock range is not locked by another thread, the lock control processing unit 33 performs locking in the lock range, and transmits the lock acquisition notification, that is, the reflection instruction of the update data 41 to the data update unit 12 or 22 of the request source. Further, the lock control processing unit 33 transmits the reflection instruction of the update data 41 converted by the data conversion processing unit 31 to the data update unit 12 or 22 of the virtual OS different from the request source.

Note that, the lock control processing unit 33 locks the lock range by setting lock acquisition information representing that the lock range for the update process is in a lock acquisition status to the lock management table 43. The lock acquisition information includes the lock key of the update target and the lock range.

Meanwhile, when the lock range is locked by another thread, that is, when the lock range is a locked resource, the lock control processing unit 33 waits until the locked lock range is released. The waiting is performed as the lock control processing unit 33 sets (registers) standby information representing that the lock range for the update process is in the lock standby status to the lock management table 43 as a request during waiting.

Further, when the lock release instruction is received from the data update unit 12 or 22 of the request source, the lock control processing unit 33 releases locking of the corresponding lock range in the lock management table 43.

Note that, when it is possible to acquire locking of the lock range on the request during waiting as the lock release is performed by the lock control processing unit 33, the request during waiting is released from the standby status according to a priority previously set by the request source and processed as the lock acquisition instruction again. Specifically, when it is possible to acquire locking of the lock range on a plurality of requests during waiting, for example, the request during waiting including the highest priority is released from the standby status and processed as the lock acquisition instruction again.

Note that, when the requests during waiting include the same priority, a corresponding request is released from the standby status according to a predetermined condition or the like decided by the virtual machine 1 such as the order in which the standby status is registered.

The lock range of the update target for the request during waiting which has been released from the standby status and then processed as the lock acquisition instruction again is locked by the lock control processing unit 33.

Note that, the processes performed by the data conversion processing unit 31 and the lock granularity determination processing unit 32 may be performed in a certain order, that is, sequentially, or may be performed in parallel. In both cases, the process performed by the lock control processing unit 33 is executed after the processes performed by the data conversion processing unit 31 and the lock granularity determination processing unit 32 are completed.

The above description has been made in connection with the example in which the date update unit 12 or 22 of the request source generates the update difference data, but the present invention is not limited to this example, and the update difference data may be generated by the lock granularity determination processing unit 32. In this case, the lock granularity determination processing unit 32 receives the pre update data and the update data 41 from the data update unit 12 or 22 of the request source and generates the update difference data.

Further, in the example illustrated in FIG. 2, all of the update data 41, the conversion instruction, the update difference data, and the lock acquisition instruction are input to the data conversion processing unit 31, but the present invention is not limited to this example. For example, the conversion instruction may be input to data conversion processing unit 31, and the lock acquisition instruction may be input to lock control processing unit 33. At this time, the change data 41 is input to the data conversion processing unit 31 together with the conversion instruction. Further, the update difference data or the pre-conversion data and the conversion data 41 when the update difference data is generated by the lock granularity determination processing unit 32 are input to the lock granularity determination processing unit 32.

Further, data such as the update difference data, the update data 41, and the lock range dealt by the update data control unit 30 may be data itself or may be information specifying corresponding data such as an address of a location (for example, the shared memory 40) storing corresponding data.

As described above, when the reflection instruction of the update data 41 is input by the update data control unit 30, the data update unit 12 and the asynchronous reflecting unit 23 or the data update unit 22 and the asynchronous reflecting unit 13 reflects (updates) the update data 41 in the corresponding first DBMS 11 and the second DBMS 21.

At this time, the data update unit 12 and the asynchronous reflecting unit 23 or the data update unit 22 and the asynchronous reflecting unit 13 reflects the update data 41 through the process according to the update request from the application 14 or 24. Examples of the reflection process of the update data 41 include a change, addition, and deletion of a row specified by the lock key for the update process in the corresponding first DBMS 11 and the second DBMS 21 by the update data 41.

Hereinafter, the data update unit 12 and the asynchronous reflecting unit 23 or the data update unit 22 and the asynchronous reflecting unit 13 which reflect the update data 41 in the first DBMS 11 and the second DBMS 21 are collectively referred to as an “update unit.”

In the change of the update data 41, for example, the update unit overwrites data in the update data 41 corresponding to the lock range in an update target region in the first DBMS 11 and the second DBMS 21, that is, a region one or more blocks) specified by an update target row and a column of the lock range.

In the addition of the update data 41, the update unit adds the update data 41 to an update target region, that is, a block in the first DBMS 11 and the second DBMS 21. Note that, when a new row is added by the addition of the update data 41, the decision of the lock range by the lock granularity determination processing unit 32 and the lock acquisition process by the lock control processing unit 33 may be omitted.

In the deletion based on the update data 41, the update unit deletes data stored in an update target region, that is, a block in the first DBMS 11 and the second DBMS 21. Note that in the update data 41 used for the deletion, “null,” an arbitrary character string representing a deletion target, or the like is set to a region of a target to be deleted by the update process, that is a region decided as the lock range.

Further, when the entire update target row is deleted in the deletion, all columns in the update target row are included in the lock range. In other words, in the update data 41 related to the update target row, for example, “null” or an arbitrary character string representing a deletion target is set to all columns. Alternatively, information representing that all columns in the update target row are deletion targets may be set to in the update data 41 related to the update target row. Further, the lock granularity determination processing unit 22 decides all columns as the lock range based on the update data 41 the update difference data).

Note that, the above-described reflection process of the update data 41 is an example, and may include various kinds of known processes such as replacement or shifting. For example, the update unit may perform the process such as replacement or shifting using one or more combinations of the change, the addition, and the deletion or using the function of the DBMS.

The shared memory 40 is a memory simultaneously accessible from the first virtual OS 10 and the second virtual OS 20.

Note that, a random access memory (RAM) may be used as the shared memory 40, but instead of a RAM, a storage device such as a hard disk drive (HDD) or a solid state drive (SSD) may be used.

The shared memory 40 stores the update data 41-1 corresponding to the format of the first DBMS 11 and the update data 41-2 corresponding to the format of the second DBMS 21. The shared memory 40 further stores the conversion definition file (conversion definition information) 42 and the lock management table (lock management information) 43.

In the present embodiment, the update data control unit 30 performs the above-described process, for example, using data, the conversion definition file, and the lock management table 43 stored in the shared memory 40.

Next, configurations of the conversion definition file 42 and the lock management table 43 will be described.

[1-1-1] Configuration of Conversion Definition File

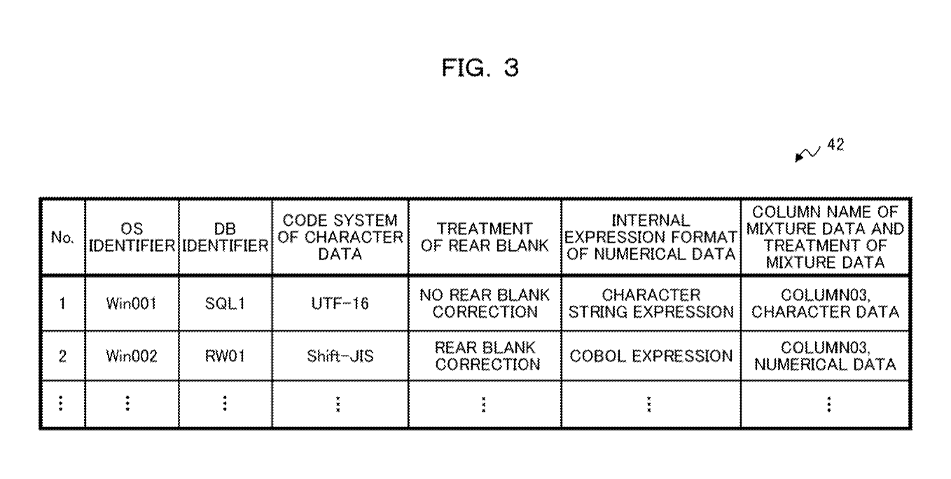

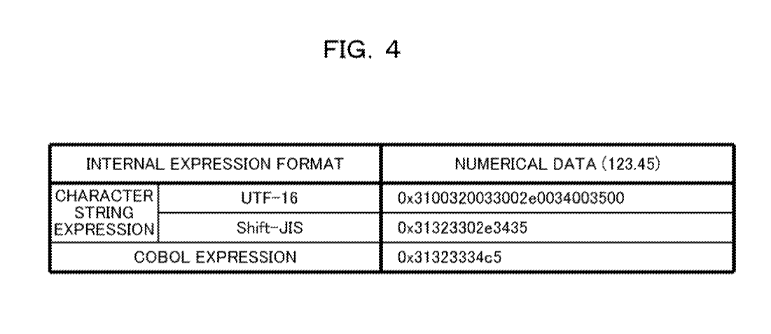

FIG. 3 is a diagram illustrating an exemplary configuration of the conversion definition file 42 according to the present exemplary embodiment. FIG. 4 is a diagram illustrating an internal expression format of numerical, data in a database according to the present exemplary embodiment, and a numerical value of “123.45” is represented by a character string expression (UTF-16), a character string expression (Shift-JIS), and a COBOL expression.

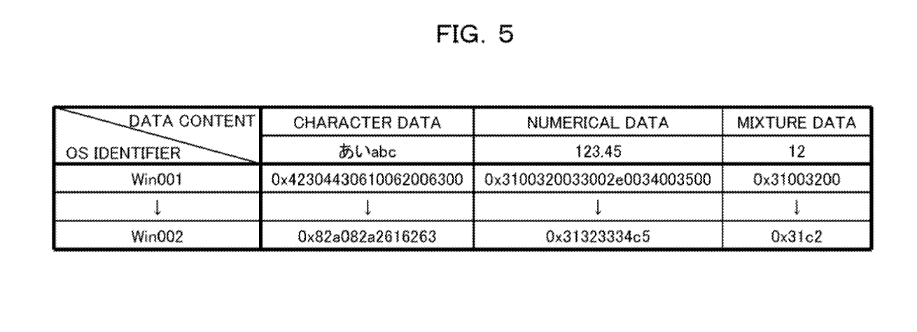

FIG. 5 is a diagram for describing a data conversion process performed by the data conversion processing unit 31 according to the present exemplary embodiment. Note that, in the example illustrated in FIG. 5, the update data 41 serving as the update target includes character data in a first column, numerical data in a second column, and mixture data in a third column. For example, the character data in a first column includes a mixture of Japanese hiragana characters representing “ai (literation)” and alphabets representing “abc” in FIG. 5.

As illustrated in FIG. 3, the conversion definition file 42 includes an OS identifier representing an OS accessing the update data control unit 30, a DB identifier (DB type) representing a type of a database, and a data characteristic corresponding to each DB identifier.

Here, in the example illustrated in FIG. 3, the data characteristic includes a code system of character data, treatment of a rear blank, en internal expression format of numerical data, a column name of mixture data including character data and numerical data, information representing treatment of mixture data, and the like.

The code system of character data represents a code system used in a database such as UTF-16 or Shift-JIS.

The treatment of a rear blank represents whether or not a blank based on a code designated by a character code system is to be set to a deficient portion when a character string length is smaller than a column length of a storage location when a character string is operated in a database.

The internal expression format of numerical data represents an expression format of numerical data inside a database such as the character string expression or the COBOL expression as illustrated in FIG. 4.

Note that in data represented by the COBOL expression, a code of “c” (positive) or “d” (negative) is set to 4 high-order bits of a last byte excluding a position of a decimal point.

The column name and the treatment of mixture data represent a column name such as “COLUMN03” illustrated in FIG. 3 and whether mixture data is dealt as character data or numerical data. Note that, the column name may be any information specifying a column such as a column number of mixture data. Further, when a database includes a plurality of tables, a table name including a corresponding column may be set together with the column name of mixture data.

The data conversion processing unit 31 decides a conversion method corresponding to each format of a conversion destination, that is, a database other than the request source based on an OS identifier and a DB identifier for the update data 41 of the conversion target, that is, the request source with reference to the conversion definition file 42.

For example, as illustrated in FIGS. 3 and 5, the data conversion processing unit 31 decides the conversion method for performing conversion into a format corresponding to an OS identifier “Win002” of a conversion destination based on the update data 41 in an OS identifier “Win001” of a conversion target, that is, a request source with reference to the conversion definition file 42. Note that, the decision of the conversion method represents, for example, decision of a conversion program for converting a format of the update data 41 of the request source into a format of a conversion destination.

Then, the data conversion processing unit 31 performs conversion according to the decided conversion method.

Specifically, the data conversion processing unit 31 converts character data in the first column in the update data 41 of the request source from UTF-16 to Shift-JIS, numerical data in the second column from the character string expression (UTF-16) to the COBOL expression, and converts mixture data in the third column from character data to numerical data as illustrated in FIG. 5. Note that, since the mixture data in the third column is converted into a data attribute designated in the conversion definition file 42, for example, character data is converted based on the code system of character data illustrated in FIG. 3, and numerical data is converted based on the internal expression format.

[1-1-2] Configuration of Lock Management Table

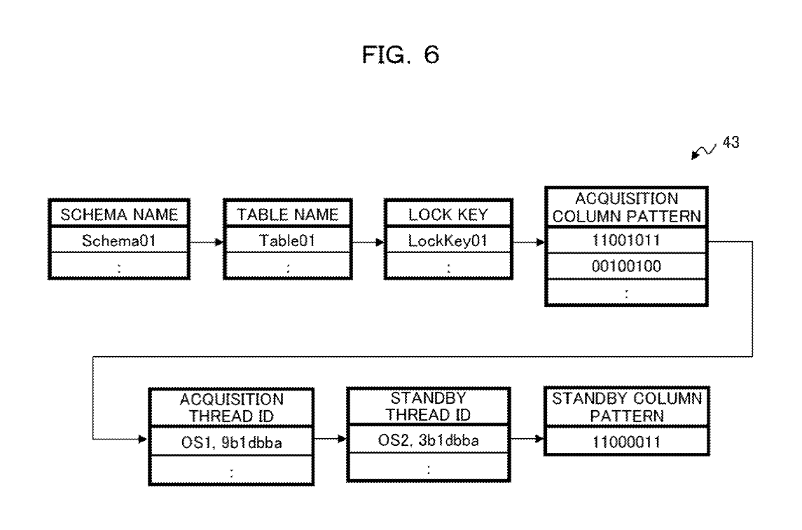

FIG. 6 is a diagram illustrating an exemplary configuration of the lock management table 43 according to the present exemplary embodiment, and FIG. 7 is a diagram for describing a column pattern in the lock management table 43 according to the present exemplary embodiment.

In the example illustrated in FIG. 6, tables of DBMSs which have been subjected to data synchronization by the virtual machine 1 are assumed to include the same schema name and the same table name and uniquely decide a row in a table by the same lock key.

Note that, as described above, in the present embodiment, the first DBMS 11 is different in the structure from the second DBMS 21. In this case, for example, a table representing a correspondence relation of a schema name, a table name, a lock key, and the like in the first DBMS 11 and the second DBMS 21 may be stored in the shared memory 40. Specifically, the table representing the correspondence relation stores a correspondence relation between the lock key of the first DBMS 11 and the to key of the second DBMS 31, a correspondence relation between the lock range of the first update data 41-1 and the lock range of the second update data 41-2, and the like.

Based on the table representing the correspondence relation, the tables in the first DBMS 11 and the second DBMS 21 can include the same name as a name referred to by the update data control unit 30.

As described above, the lock control processing unit 33 can control database locking on all DBMS serving as the synchronization target, that is, the first DBMS 111 and the second DBMS 21 in the present embodiment based on the lock management table 43.

The lock statuses of the first DBMS 11 and the second DBMS 21 are set to the lock management table 43.

As illustrated in FIG. 6, the lock management table 43 includes a schema name table, a table name table, a lock key table, an acquisition column pattern table, an acquisition thread ID table, a standby thread ID table, and a standby column pattern table.

A schema name including data acquired by the lock control processing unit 33, that is, the lock range for the update process is set to the schema name table. When all lock ranges including the same schema name are released, the schema name in which all lock ranges have been released is deleted from the schema name table.

A table name including data acquired by the lock control processing unit 33, that is the lock range for the update process is set to the table name table. When all lock ranges including the are table name are released, the table name in which all lock ranges have been released is deleted from the table name table.

A lock key used to uniquely decide a row including data acquired by the lock control processing unit 33, that is, the lock range for the update process is set to the lock key table. When all lock ranges including the same lock key are released, the lock key in which all lock ranges have been released is deleted from the lock key table.

Column patterns which the lock control processing unit 33 has acquired in rows specified by the schema name table, the table name table, and the lock key table are set to the acquisition column pattern table. The acquisition column pattern is deleted when data including a column pattern, that is, the lock range is released.

Similarly to the column pattern, the acquisition column pattern is a bit string of 1 (row)×m (column) (m is the number of columns configuring a row) in which a acquisition target column to be locked by the lock control processing unit 33 is “1” and a non-acquisition target column is “0.”

For example, as illustrated in FIG. 7, when a single row in a database includes 8 columns and first, third, and eighth columns are decided as the lock range by the lock granularity determination processing unit 32, an acquisition column pattern is “10100001.”

An acquisition thread ID including a column pattern which is acquired by the lock control processing unit 33 and stored in the acquisition column pattern table is set to the acquisition thread ID table. The acquisition thread ID is deleted when the lock range including the column pattern is released.

Note that, the acquisition thread ID is an identifier (acquisition identifier) in which an OS identifier of the request source of the lock acquisition in is combined with a thread ID.

An ID of a thread which is on standby (waiting) for acquisition of a column pattern stored in the acquisition column pattern table is set to the standby thread ID table as a standby thread ID. The standby thread ID is deleted when the standby status is released.

Note that, the standby thread ID is an identifier (acquisition identifier) in which an OS identifier of the request source of the lock acquisition instruction is combined with a thread ID.

The lock range, that is, a column pattern of a processing target in the standby thread ID in the standby status stored in the standby thread ID table is set to the standby column pattern table. The standby column pattern is deleted when the standby status is released.

The lock control processing unit 33 determines whether or not locking can be acquired in the lock range for the update process based on the lock management table 43.

Specifically, the lock control processing unit 33 obtains a logical product (AND) of the lock range, that is, the column pattern of the processing target and all the acquisition column patterns in the acquisition column pattern table for each column, and determines that locking of the lock range can be acquired when all columns are “0” as a result of the logical product (AND). However, when there is a column other than “0” as a result of the logical product (AND), the lock control processing unit 33 determines that locking of the lock range can be un-acquired, and performs the above-described standby process.

Then, when the lock control processing unit 33 determines that locking can be acquired, the OS identifier of the instruction source, the lock key, the acquisition column pattern, and the thread ID are set to the lock management table 43 as the lock acquisition information.

Meanwhile, when the lock control processing unit 33 determines that locking can be un-acquired, the standby column pattern and the standby thread ID are set to the lock management table 43 as standby information representing that the lock range for the update process is in the lock standby status.

Further, when the lock release instruction is input from the data update unit 12 or 22, the lock control processing unit 33 deletes the lock venue related to the lock release instruction from the lock acquisition column pattern, and determines whether or not there is a standby column pattern in which locking can be acquired by the release of the lock range. Then, when there is a standby column pattern in which locking can be acquired, the lock control processing unit 33 processes the standby column pattern as new lock acquisition instruction on the instruction source OS identifier or the lock range related to the standby column pattern.

Note that, depending on the standby column pattern, there are cases in which it is difficult to acquire locking of the lock range, for the update process unless a plurality of acquisition column patterns are released. In this case, the lock control processing unit 33 registers the standby thread ID and the standby column pattern in association with each of the acquisition thread IDs of the plurality of acquisition column patterns. Then, the lock control processing unit 33 acquires locking on a part of the lock range related to the standby column pattern when locking is released in a plurality of acquisition column pattern. As described above, when locking can be acquired on the entire lock range related to the standby column pattern such that locking is partitively acquired on the lock range related to the standby column pattern, the lock control processing unit 33 outputs the reflection instruction for the standby column pattern.

As described above, the lock control processing unit 33 can control locking of a plurality of databases such as the first DBMS 11 and the second DBMS 21 through the single lock management table 43, that is, as lock management mechanism.

As described above, the update data control unit 30 and the shared memory 40 function as a data synchronization control device that performs database synchronization control between the first virtual OS 10 and the second virtual OS 20.

### [1-2] Operation According to Embodiment

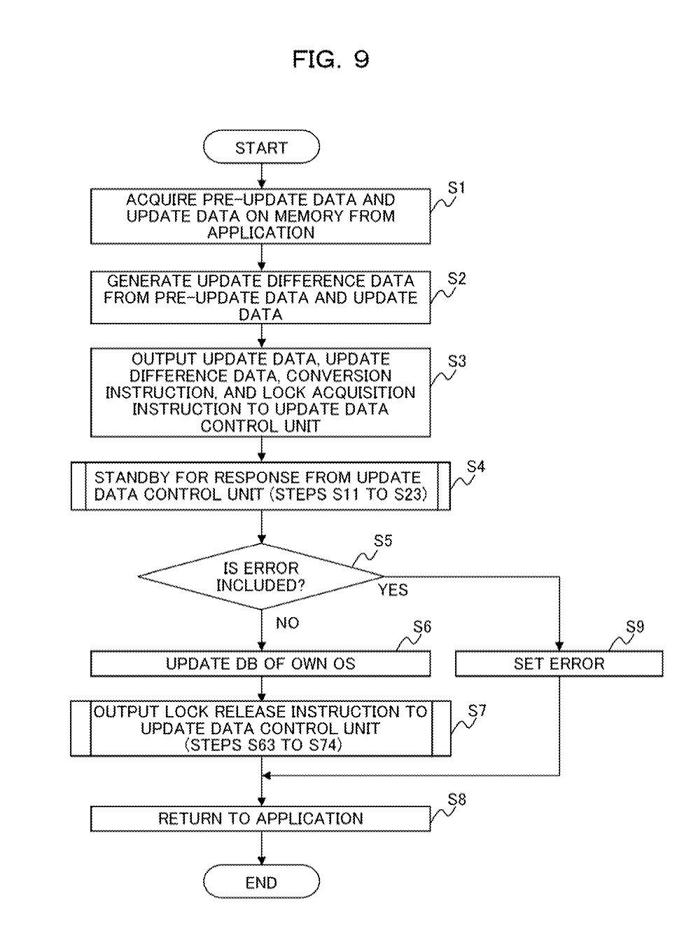

Next, the data synchronization process performed, by the virtual machine 1 including the above-described configuration will be described with reference to a sequence diagram illustrated in FIG. 5, and detailed processes of the components of the virtual machine 1 will be described with reference to flowcharts illustrated in FIGS. 9 to 15.

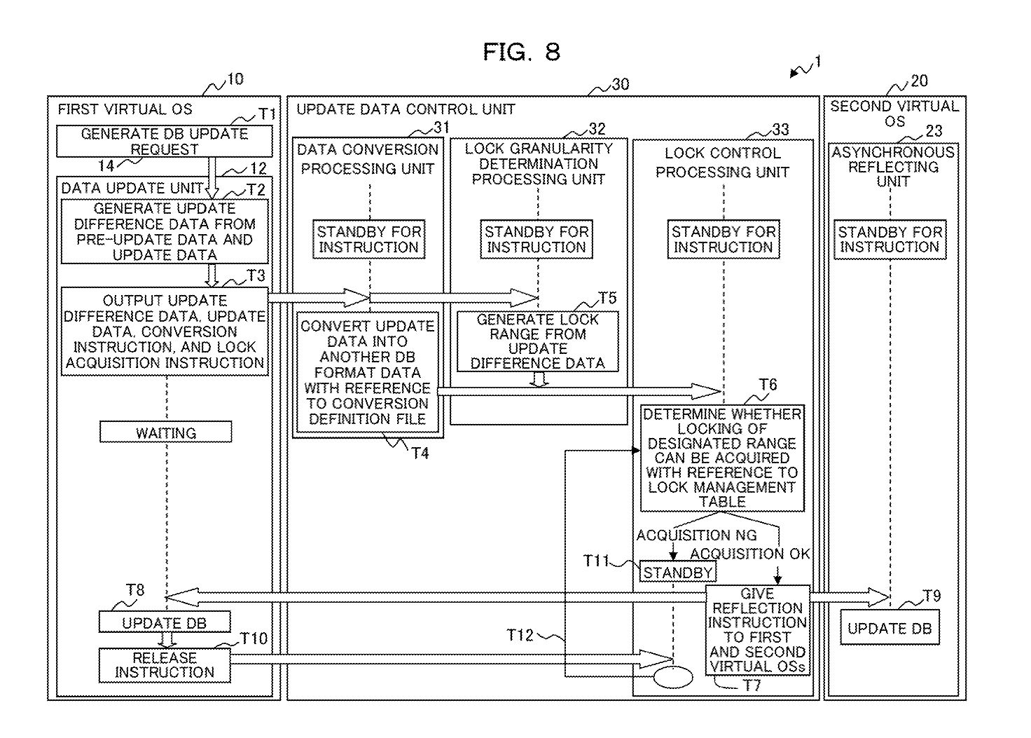

FIG. 8 is a sequence diagram for describing the data synchronization process performed by the virtual machine 1.

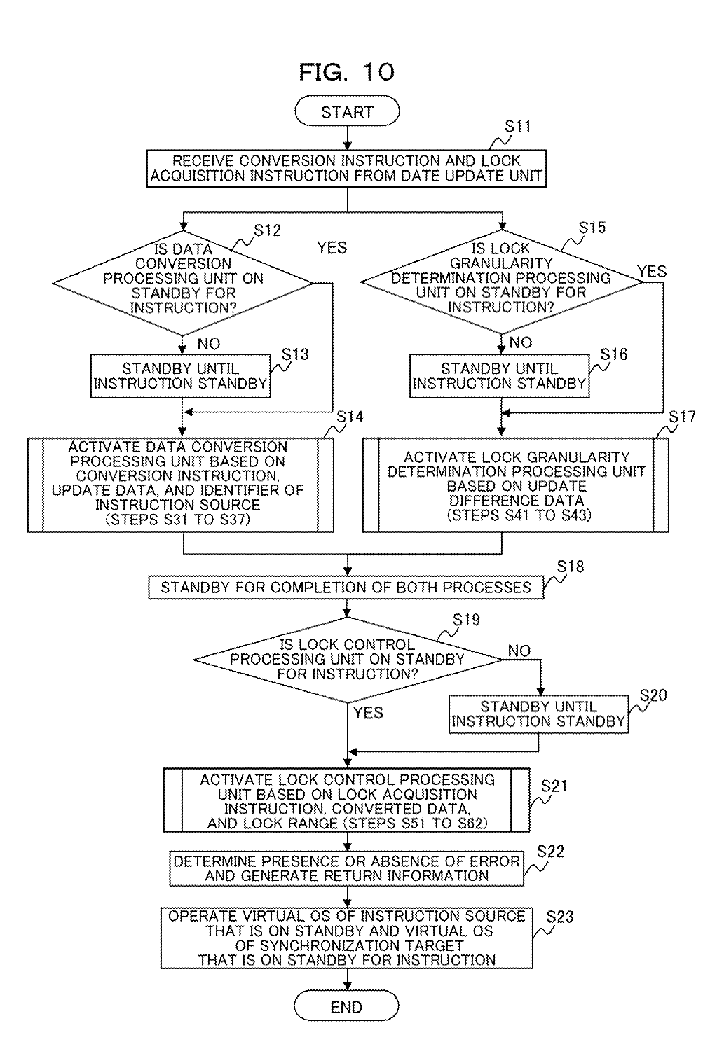

FIG. 9 is a flowchart for describing a process of the data update unit 12 or 22 according to the present exemplary embodiment, and FIG. 10 is a flowchart for describing the data conversion and lock acquisition processes of the update data control unit 30.

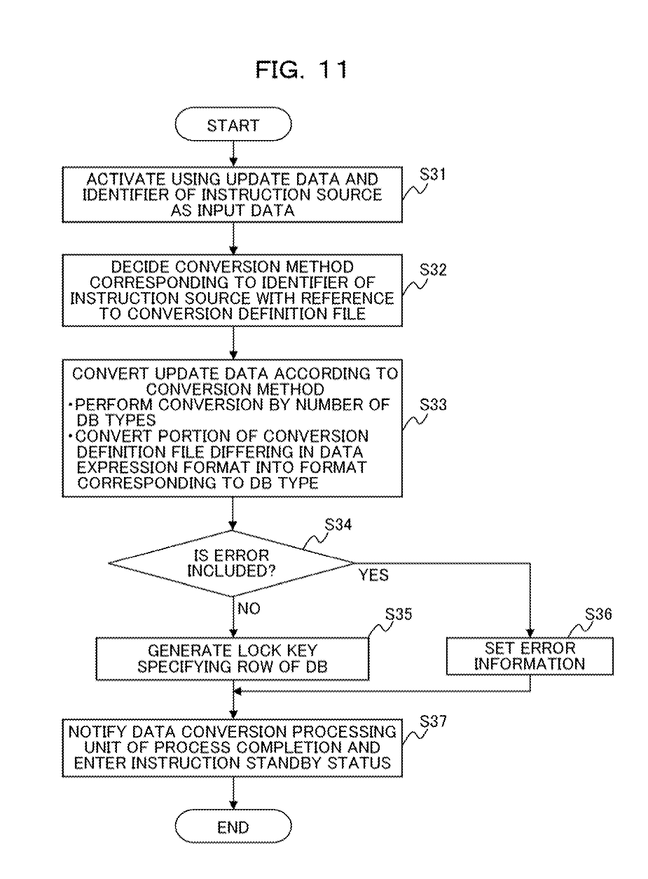

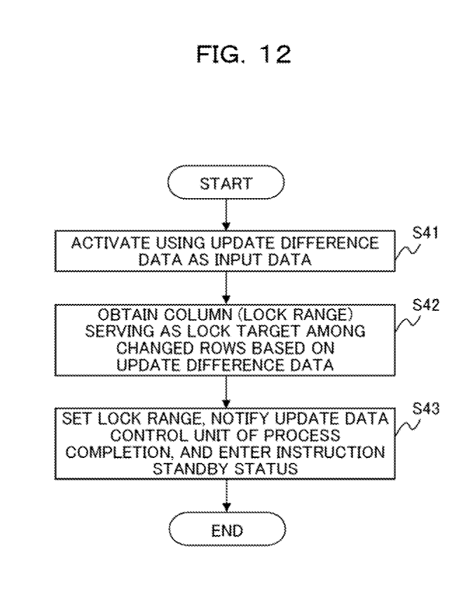

FIG. 11 is a flowchart for describing the data conversion process of the data conversion processing unit 31 according to the present exemplary embodiment, and FIG. 12 is a flowchart for describing the lock range decision process of the lock granularity determination processing unit 32.

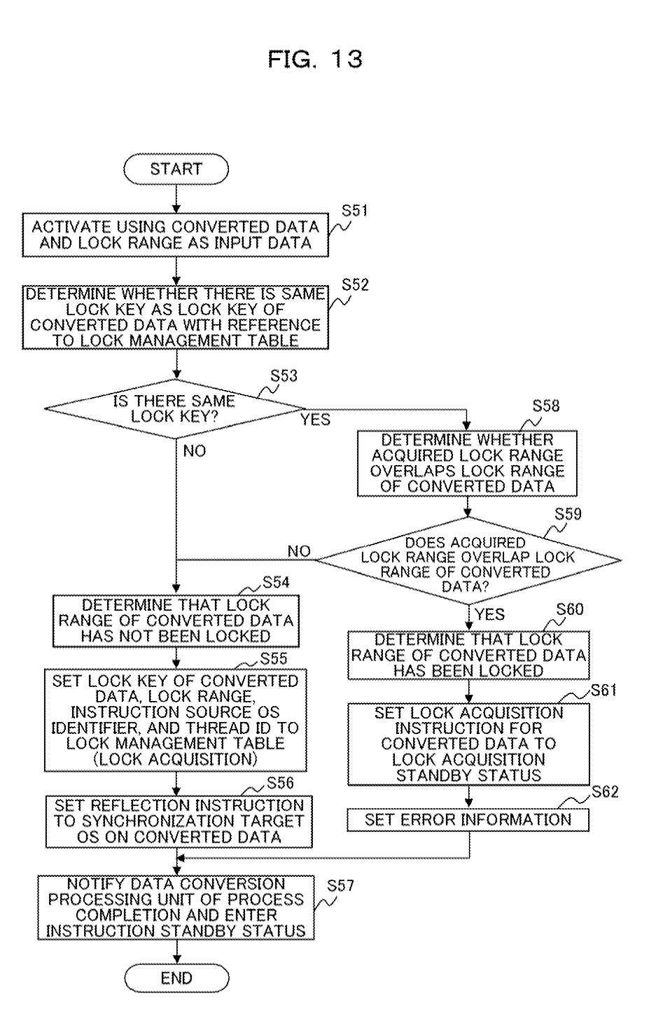

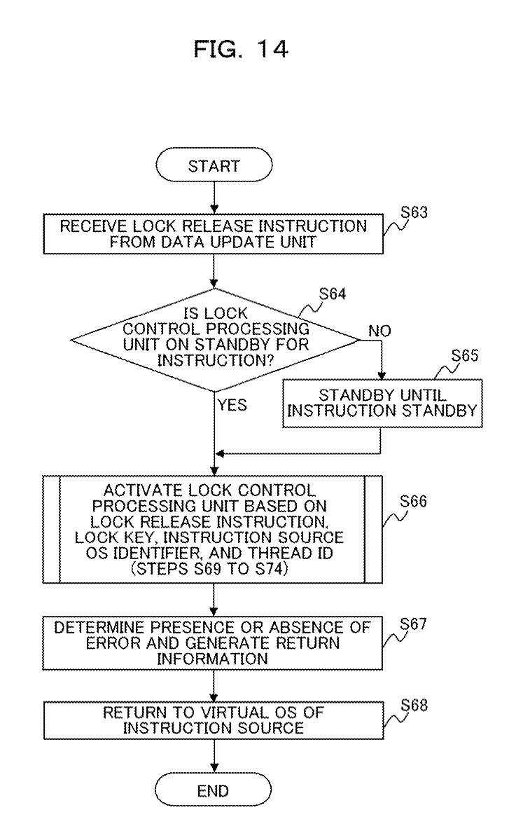

FIG. 13 is a flowchart for describing the lock acquisition process performed by the lock control processing unit 33 according to the present exemplary embodiment, and FIG. 14 is a flowchart for describing the lock release process of the update data control unit 30.

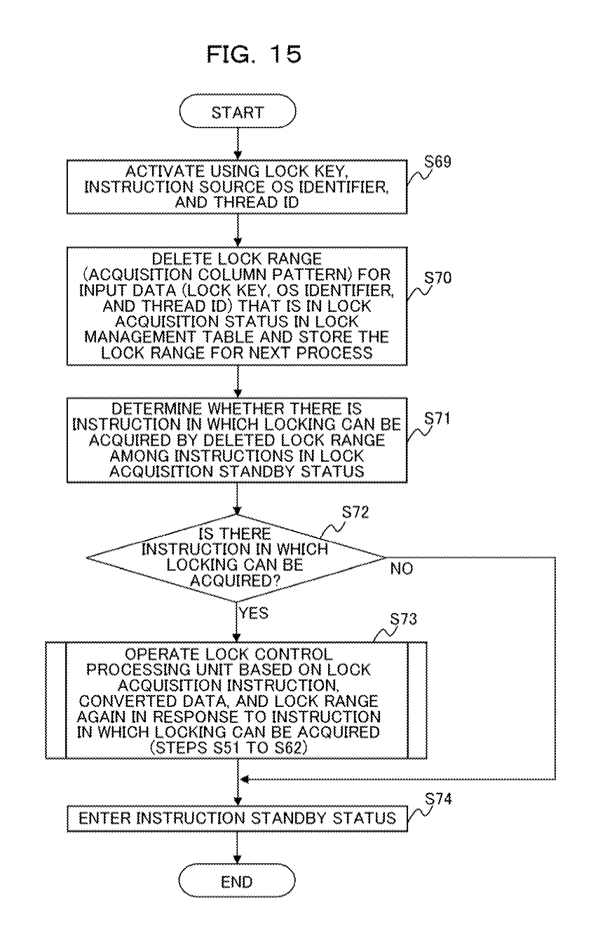

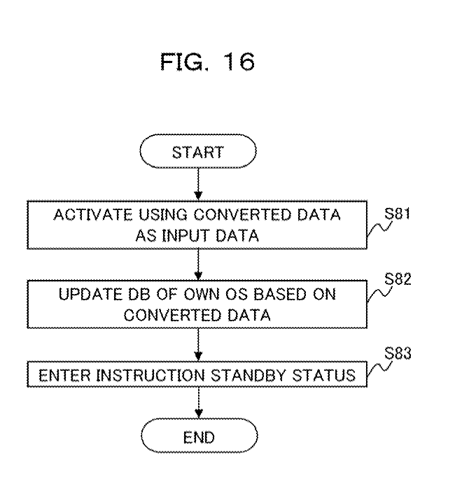

FIG. 15 is a flowchart for describing the lock release process performed by the lock control processing unit 33 according to the present exemplary embodiment, and FIG. 16 is a flowchart for describing a process of the asynchronous reflecting unit 13 or 23.

A process performed by the virtual machine 1 when the application 14 of the first virtual OS 10 updates the first DBMS 11 will be described below.

First of all, as illustrated in FIG. 5, the application 14 of the first virtual OS 10 generates an update processing request for the first DBMS 11, and outputs the request to the data update unit 12 (step T1).

When an update request is input, as illustrated in FIG. 9, the data update unit 12 acquires the pre-update data and the updated data 41-1 for the update process performed on the first DBMS 11 from the application 14 (step S1). Note that, since the pre-update data and the updated data 41-1 are stored in a memory accessible by the application 14, the data update unit 12 acquires the pre-update data and the updated data 41-1 from the memory through the application 14.

Then, the data update unit 12 generates update difference data based on the pre-update data and the updated data 41-1 (steps S2 and T2).

Next, the data update unit 12 outputs the updated data 41-1 and the update difference data, and, the conversion instruction and the lock acquisition instruction to the update data control unit 30 (steps S3 and T3). When each data and each instruction are output to the update data control unit 30, the data update unit 12 completes the process (steps S11 to S23 of FIG. 10) in the update data control unit 30, and waits until a response is input from the update data control unit 30 (step S4).

When the conversion instruction and the lock acquisition instruction are input from the data update unit 12 (step S11), as illustrated in FIG. 10, the update data control unit 30 determines whether or not the data conversion processing unit 31 is on standby for an instruction (step 212).

When the data conversion processing unit 31 is on standby for an instruction (a Yes route in step S12), the update data control unit 30 outputs the conversion instruction, the updated data 41-1, and the OS identifier and the DB identifier of the instruction source to the data conversion processing unit 31, and activates the data conversion processing unit 31 (step S14). The data conversion processing unit 31 executes a predetermined process (step T4 and steps S31 to S37 of FIG. 11 which will be described later) in response to the conversion instruction.

Meanwhile, when the data conversion processing unit 31 is performing another process, that is, not on standby for an instruction (a No route in step S12), the update data control unit 30 is on standby until the data conversion processing unit 31 enters an instruction standby status (step S13), and when the data conversion processing unit 31 enters the instruction standby status, the process proceeds to step S14.

Further, when the conversion instruction and the lock acquisition instruction are input from the data update unit 12 (step S11), the update data control unit 30 determines whether or not the lock granularity determination processing unit 32 is on standby for an instruction (step S15).

When the lock granularity determination processing unit 32 is on standby for an instruction (a Yes route in step S15), the update data control unit 30 inputs the update difference data to the lock granularity determination processing unit 32, and activates the lock granularity determination processing unit 32 (step S17). The lock granularity determination processing unit 32 executes a predetermined process (step T5 and steps S41 to S43 of FIG. 12 which will be described later) related to decision of the lock granularity (the lock range).

Meanwhile, when the lock granularity determination processing unit 32 is performing another process, that is, not on standby for an instruction (a No route in step S15), the update data control unit 30 waits until the lock granularity determination processing unit 32 enters an instruction standby status (step S16), and when the to granularity determination processing unit 32 enters the instruction standby status, the process proceeds to step S17.

Note that the process of steps S12 to S14 and the process of steps S15 to S17 may be performed in parallel or in a certain order.

The update data control unit 30 waits until both the process of steps S12 to S14 and the process of steps S15 to S17 are completed as illustrated in FIG. 10 (step S18).

Here, an operation of the data conversion processing unit 31 in step S14 will be described.

In the data conversion processing unit 31, as illustrated in FIG. 11, the update data control unit 30 receives the updated data 41-1 and the OS identifier and the DB identifier of the instruction source as input data (step S31).

Then, the data conversion processing unit 31 decides the conversion method corresponding to the OS identifier and the DB identifier of the instruction source with reference to the conversion definition file 42 which is set in advance (step S32, see FIG. 3).

Next, the data conversion processing unit 31 converts the updated data (update data) 41-1 into the update data (converted data) 41-2 corresponding to the format of the second DBMS 21 according to the conversion method decided in step S32 (steps S33 and T4).

Note that, in step S33, the data conversion processing unit 31 converts the update data 41-1 by the number of types of other DBMSs of the data synchronization target, that is, for each of the types of other DBMSs of the data synchronization target. The data conversion processing unit 31 converts a portion differing in the data expression format in the conversion definition file 42 into formats corresponding to the types of other DBMSs of the data synchronization target. In other words, for example, when a data expression format of an item (column) of the update data 41-1 is different from a data expression format of an item (column) in other DBMSs of the data synchronization target, the data conversion processing unit 31 performs conversion of a corresponding item (column) of the update data 41-1.

When conversion of the update data 41-1 is completed, the data conversion processing unit 31 performs error determination (step S34). In the error determination, it is checked whether or not there is a conversion error caused by abnormality of the conversion definition file 42, abnormality of the update data 41, abnormality of hardware, or the like.

When it is determined that there is no conversion error as a result of error determination (a No route in step S34), the data conversion processing unit 31 generates the lock key specifying a row including the update data 41 in the first DBMS 11 and the second DBMS 21 (step S35).

However, when it is determined that the is a conversion error as a result of error determination (a Yes route in step S34), the data conversion processing unit 31 sets error information based on the conversion error (step S36).

Then, the data conversion processing unit 31 notifies the update data control unit 30 of completion of the process, and the data conversion processing unit 31 transitions to the instruction standby status (step S37). Note that, when there is a conversion error and the error information is set in step S36, the update data control unit 30 is notified of the error information together with the process completion notification.

Next, an operation of the lock granularity determination processing unit 32 in step S17 illustrated in FIG. 10 will be described.

In the lock granularity determination processing unit 32, as illustrated in FIG. 12, the update data control unit 30 receives the update difference data as input data (step S41).

Then, the lock granularity determination processing unit 32 decides a column serving as a lock target in a changed row, that is, the lock range based on the update difference data (steps S42 and T5).

Finally, the data conversion processing unit 31 sets the lock range, and notifies the update data control unit 30 of the set lock range together with the process completion notification. Then, the data conversion processing unit 31 transitions to the instruction standby status (step S13).

When the processes of both the data conversion processing unit 31 and the lock granularity determination processing unit 32 are completed, that is, when a notification representing that the two processes are completed is input, the update data control unit 30 determines whether or not the lock control processing unit 33 is on standby for an instruction as illustrated in FIG. 10 (step S19).

When the lock control processing unit 33 is on standby for an instruction (a Yes route in step S19), the update data control unit 30 inputs the lock acquisition instruction, the converted data 41-1, and the lock range to the lock control processing unit 33, and activates the lock control processing unit 33 (step S21). The lock control processing unit 33 executes a predetermined process (steps T6, T7, and T11 and steps S51 to S62 of FIG. 13 which will be described later) in response to the lock acquisition instruction.

Meanwhile, when the lock control processing unit 33 is performing another process, that is, not on standby for an instruction (a No route in step S19), the update data control unit 30 waits until the lock control processing unit 33 enters the instruction standby status (step S20), and when the lock control processing unit 33 enters the instruction standby status, the process proceeds to step S21.

Here, an operation of the lock control processing unit 33 in step S21 will be described.

The lock control processing unit 33 that has received the lock acquisition instruction receives the converted data 41-2 and the lock range decided by the lock granularity determination processing unit 32 as input data as illustrated in FIG. 13 (step S51).

Then, the lock control processing unit 33 determines whether or not the same lock key as the lock key for the update process generated by the data conversion processing unit 31 is included in the lock management table 43 with reference to the lock management table 43 (steps S52 and S53).

When it is determined that the same lock key as the lock key for the update process is not included in the lock management table 43 (a No route in step S53), the lock control processing unit 33 determines that the lock range of the conversion data 41 for the update process is in an “unlocked” status, that is, a non-locked status (step S54).

Then, the lock control processing unit 33 sets the lock key of the update data 41-2 for the update process, the lock range represented by the acquisition column pattern, the OS identifier of the instruction source, and the thread ID to the lock management table 43 (step S55, see FIG. 6). In other words, in step S55, the lock control processing unit 33 sets information representing that the or range for the update process is locked to the lock management table 43 as the lock acquisition information.

When the lock range for the update process is locked, the lock control processing unit 33 sets the reflection instruction to the second DENS 21 on the update data 41-2 (step S56).

Finally, the lock control processing unit 33 notifies the update data control unit 30 of the converted data 41-2 and the set reflection instruction together with the process completion notification. Then, the lock control processing unit 33 transitions to the instruction standby status step S57).

Meanwhile, when it is determined in step S53 that the same lock key as the lock key for the update process is Included in the lock management table 43 (a Yes route in step S53), the lock control processing unit 33 determines whether or not the lock range acquired in the lock management table 43 overlaps the lock range for the converted data 41-2 (steps S58 and S59).

In other words, in steps S58 and S59, the lock control processing unit 33 determines whether or not there is a range common to the lock range corresponding to the lock key included in the lock management table 43 and the lock range for the update process. For example, the determination is made by obtaining a logical product (AND) of the lock range for the update process, that is, the column pattern of the processing target and each of all acquisition column patterns in the acquisition column pattern table for each column.

When it is determined that the acquired lock range does not overlap the lock range for the converted, data 41-2 (a No route in step S59), the lock control processing unit 33 determines that the lock range for the update process is in the “unlock” status, and the process proceeds to step S54.

However, when this determined that the acquired lock range overlaps the lock range for the converted data 41-2 (a Yes route in step S59), the lock control processing unit 33 determines that the lock range of the conversion data 41 for the update process is in the “locked” status, that is, the already locked status (step S60).

Then, the lock control processing unit 33 sets standby information representing that locking of the first and second databases for the update process, that is, the lock range for the update process is in the lock standby status to the lock management table 43 (steps S61 and T11).

In other words, in step S61, the lock control processing unit 33 performs a setting such that the lock range and the standby thread ID represented by the standby column pattern are associated with the acquisition thread ID of the lock acquisition standby in the lock management table 43 (see FIG. 6).

The lock control processing unit 33 sets error information representing that it is difficult to acquire locking of the lock range for the update process (step S62), and the process proceeds to step S57. Further, note that, when the error information is set is step S52, the lock control processing unit 33 adds the error information to the process completion notification given to the update data control unit 30 instead of the update data 41-2 and the reflection instruction.

When the process of the lock control processing unit 33 is completed, that is, when the process completion notification is input, the update data control unit 30 determines the presence or absence of an error, and generates return information as illustrated in FIG. 10 (step S22).

Here, the determination on the presence or absence of an error by the update data control unit 30 is performed by determining whether or not the error information is included in the process completion notification input from the data conversion processing unit 31 or the of control processing unit 33.

The return information is notification information which is given to the first virtual OS 10 of the instruction source or/and the second virtual OS 20 of the synchronization target, and includes the reflection instruction of the update data 41 to be directed to each DBMS, data conversion and lock acquisition notification from the processing units 31 to 33, the error information notified when the error information is input, and the like.

Note that, when an error causing the update process to stop has occurred, for example, when conversion is not performed in the data conversion processing unit 31 due to abnormality of the conversion definition file 42, for example, a predetermined message may be set to the return information. Further, in the lock control processing unit 33, even when an error causing the update process to temporarily stop has occurred, for example, when it is difficult to acquire locking of the lock range for the update process and the standby information is set, for example, a predetermined message may be set to the return information.

Then, the update data control unit 30 outputs the return information to the first virtual OS 10 of the instruction source or/and the second virtual OS 20 of the synchronisation target, and releases the standby status or the instruction standby status of the OSs (steps S23 and T7). In other words, the reflection instruction of the update data 41-1 to be directed to the first virtual OS 10 of the instruction source and the reflection instruction of the converted data 41-2 to be directed to the second virtual OS 20 of the synchronisation target are output at the same timing or at approximately the same timing.

The data update unit 12 that has been released from the standby status as the return information (the reflection instruction) is input determines whether or not the error information is included in the return information as illustrated in FIG. 9 (step S5).

When it is determined that the error information is not included as a result of error determination (a No route in step S5), the data update unit 12 updates the first DBMS 11 in its own OS, that is, the first virtual OS 10 using the update data 41-1 (steps 26 and T8).

Then, the data update unit 12 outputs the lock release instruction for the lock range for the update process to the update data control unit 30 (steps S7 and T10), and the update data control unit 30 executes a process (step T12 and steps S63 to S74 of FIGS. 14 and 15 which will be described later) in response to the lock release instruction.

Thereafter, the data update unit 12 notifies the application 14 of the completion of the update process, the process of the application 14 returns (step S8), and the process of the data update unit 12 ends.

Meanwhile, when it is determined in step S5 that the error information is included as a result of error determination (a Yes route in step S5), the data update unit 12 sets the error information to the update process execution result (step S9), the execution result is output to the application 14, and the process proceeds to step S8.

Further, the asynchronous reflecting unit 23 of the second virtual OS 20 that has been released from the instruction standby status as the return information (the reflection instruction) is input receives the update data (converted data) 41-2 as input data from the update data control unit 30 as illustrated in FIG. 16 (step S81).

Note that, the asynchronous reflecting unit 23 receives an address of the shared memory 40 storing the converted data 41-2, for example, from the update data control unit 30, accesses the received address, and can acquire the converted data 41-2.

Then, the asynchronous reflecting unit 23 updates the second DBMS 21 in its own OS, that is, the second virtual OS 20 using the update data 41-2 (steps S82 and T9).

When the updating of the update data 41-2 to the second DBMS 21 is completed, the asynchronous reflecting unit 23 transitions to the instruction standby status (step S83), and the process of the asynchronous reflecting unit 23 ends.

Next, an operation of the update data control unit 30 in response to the lock release instruction in step S7 illustrated an FIG. 9 will be described.

Upon receiving the lock release instruction from the data update unit 12 as illustrated in FIG. 14 (step S63), the update data control unit 30 determines whether or not the lock control processing unit 33 is on standby for an instruction (step S64).

When the lock control processing unit 33 is on standby for an instruction (a Yes route in step S64), the update data control unit 30 inputs the lock key for the lock release instruction, the OS identifier of the instruction source, and the thread ID to the lock control processing unit 33 together with the lock release instruction, and activates the lock control processing unit 33 (step S66). The lock control processing unit 33 executes a predetermined process (step T12 and steps S69 to S74 of FIG. 15 which will be described later) in response to the lock release instruction.

Meanwhile, when the lock control processing unit 33 is performing another process, that is, not on standby for an instruction (a No route in step S64), the update data control unit 30 waits until the lock control processing unit 33 enters an instruction standby status (step S65), and when the lock control processing unit 33 enters an instruction standby status, the process proceeds to step S66.

Next, an operation of the lock control processing unit 33 in step S66 will be described.

The lock control processing unit 33 that has received the lock release instruction receives the lock key, the OS identifier of the instruction source, and the thread ID as input data as illustrated in FIG. 15 (step S69).

Then, the lock control processing unit 33 deletes the lock range (the acquisition column pattern) for the input data (the lock key, the OS identifier of the instruction source, and the thread ID) which is in the lock acquisition status with reference to the lock management table 43. Not that, at this time, the lock control processing unit 33 stores the column pattern of the deleted lock range (step S70).

Next, the lock control processing unit 33 determines whether or not there is an instruction in which locking can be acquired by the deleted lock range among the instructions in the lock acquisition standby status (step S71). Note that, the instruction in the lock acquisition standby status is represented by the standby thread ID and the standby column pattern set to the lock management table 43 (see FIG. 6).

When it is determined that there is an instruction in which locking can be acquired by the deleted lock range among the instructions in the lock acquisition standby status (a Yes route in step S72), the lock control processing unit 33 performs the lock acquisition process again in response to the instruction in which locking earl be acquired (step S73). In other words, the lock control processing unit 33 executes the process of steps S51 to S62 using the lock acquisition instruction, the conversion data 41-2, and the lock range as input data in response to the instruction in which locking can be acquired.

Next, the lock control processing unit 33 notifies the update data control unit 30 of completion of the process. Then, the lock control processing unit 33 enters the instruction standby status (step S74).

Further, when it is determined that there is no instruction in which locking can be acquired among the instructions in the lock acquisition standby status (a No route in step S72), the lock control processing unit 33 enters the instruction standby status of step S74.

When the process of the lock control processing unit 33 is completed, that is, when the process completion notification is input, the update data control unit 30 determines the presence or absence of an error, and generates return information as illustrated in FIG. 14 (step S67).

Here, the determination on the presence or absence of an error by the update data control unit 30 is performed by determining whether or not the error information is included in the process completion notification input from the lock control processing unit 33.

The return information is notification information to be directed to the first virtual OS 10 of the instruction source, and includes, for example, the error information notified when the error information is input.

Then, the update data control unit 30 outputs the return information to the first virtual OS 10 of the instruction source, the process of the first virtual. OS 10 returns (step S68), and the process of the update data control unit 30 ends.

As described above, according to the update data control unit 30 of the present exemplary embodiment, the data conversion processing unit 31 acquires the first update data 41-1 for the update process performed on the first DBMS 11. Further, the data conversion processing unit 31 converts the first update, data 41-1 into the second update data 42-2 corresponding to the format of the second DBMS 21 based on the previously set conversion definition file (conversion definition information) 42.

As a result, when synchronization of the update data 41 is performed between the first DBMS 11 and the second DBMS 21 including different structures from each other, the application 14 has to only include the update data control unit 30 as in the related art and can convert the update data 41 to be synchronized between the first DBMS 11 and the second DBMS 21. In other words, the update data control unit 30 can synchronize only the update data 41 between the first DMS 11 and the second DBMS 21 including different structures from each other without changing the application 14 or the first DBMS 11 and the second DBMS 21.

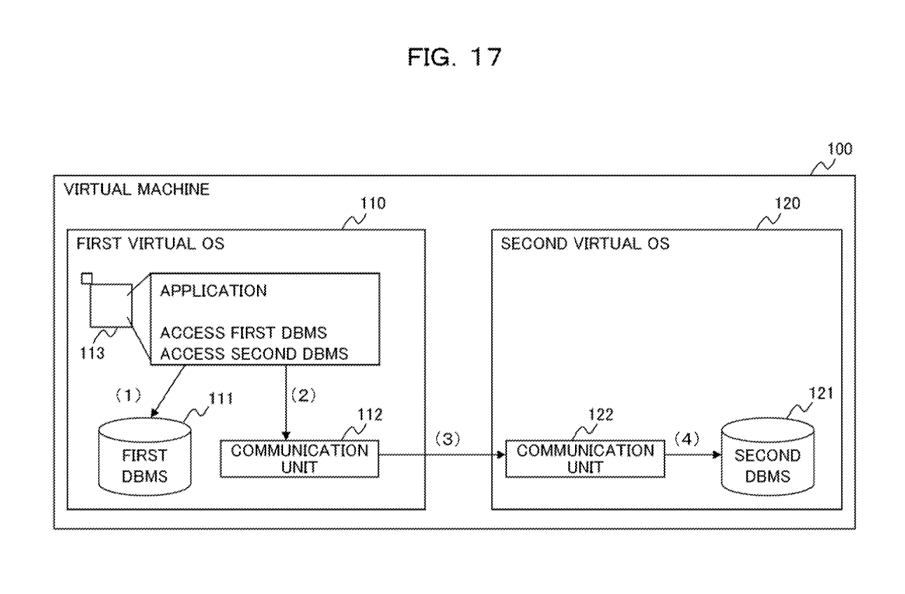

Thus, the update data control unit 30 can suppress en increase in maintenance man-hours caused by a change in the program of the application 14, and the update data 41 to be synchronized can be more easily converted between the first DBMS 11 and the second DBMS 21 than in the example illustrated in FIG. 17.

Further, according to the update data control unit 30 of the present exemplary embodiment, the lock granularity determination processing unit 32 decides the lock range based on the first update data 41-1 and the ore-update data that has not been subjected to the update process. At this time, the lock range is decided using column of a table in the first DBMS 11 and the second DBMS 21 as a minimum unit. Further, the lock control processing unit 33 locks the first DBMS 11 and the second DBMS 21 based on the lock range decided by the lock granularity determination processing unit 32.

As a result, when synchronization of the update data 41 is performed between the first DBMS 11 and the second DBMS 21, the lock range of the first DBMS 11 and the second DBMS 21 can be decided in units of 1 (row)×1 (column) blocks smaller than units of rows in the related art. Thus, since the lock range is decided by a region one or more blocks) specified by an update target row and a column in the lock range, the lock range can be suppressed to the minimum.

Further, for example, when one or more blocks in a certain table are referred to by a view, although a block which is not referred to by a view is updated by another application, since only one or more updated blocks axe locked as the lock range, influence on reference via a view can be suppressed. In other words, it is possible to suppress the occurrence of simultaneous update and access on the same resource of a database to the minimum.

Further, even when a time in which the lock range of the first DBMS 11 and the second. DBMS 21 is locked increases due to a certain reason, since locking is performed in units of blocks finer than units of rows, a range in which exclusive control is performed on a database by locking can be suppressed to the minimum. In other words, the exclusive control can be performed in the state in which a lock status of one database matches a lock status of the other database. Thus, a shared degree of database resources can be improved.

Further, according to the update data control unit 30 of the present exemplary embodiment, the lock control processing unit 33 locks the first DBMS 11 and the second DBMS 21 based on the lock range decided by the lock granularity determination or unit 32. Then, the lock control processing unit 33 instructs CBs arranged in the first DBMS 11 and the second DBMS 21 to perform updating using the first update data 41-1 and the second update data 41-2, respectively. At this time, the lock control processing unit 33 outputs the second update data 41-2 to the second virtual OS 20 through the shared memory 40 accessible from the first virtual OS 10 and the second virtual OS 20.

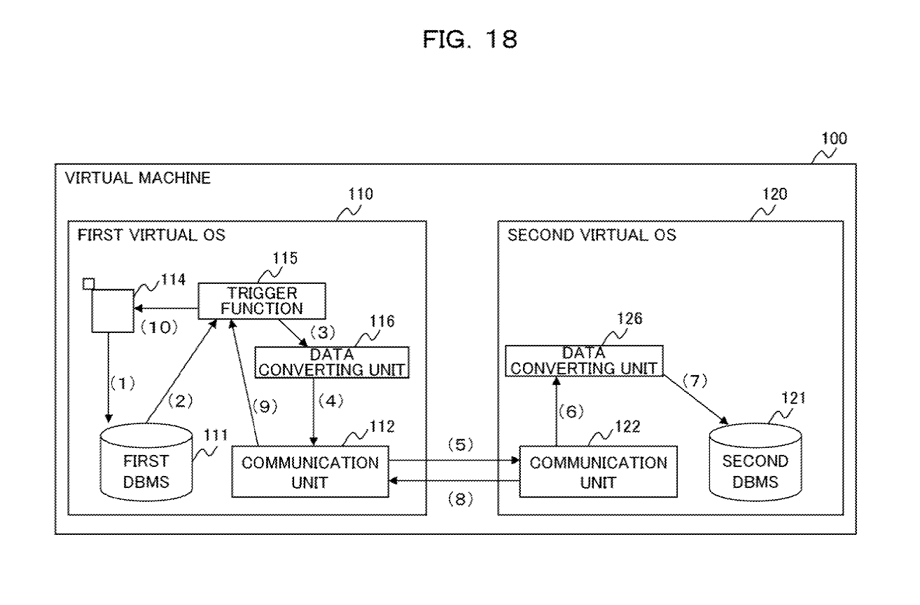

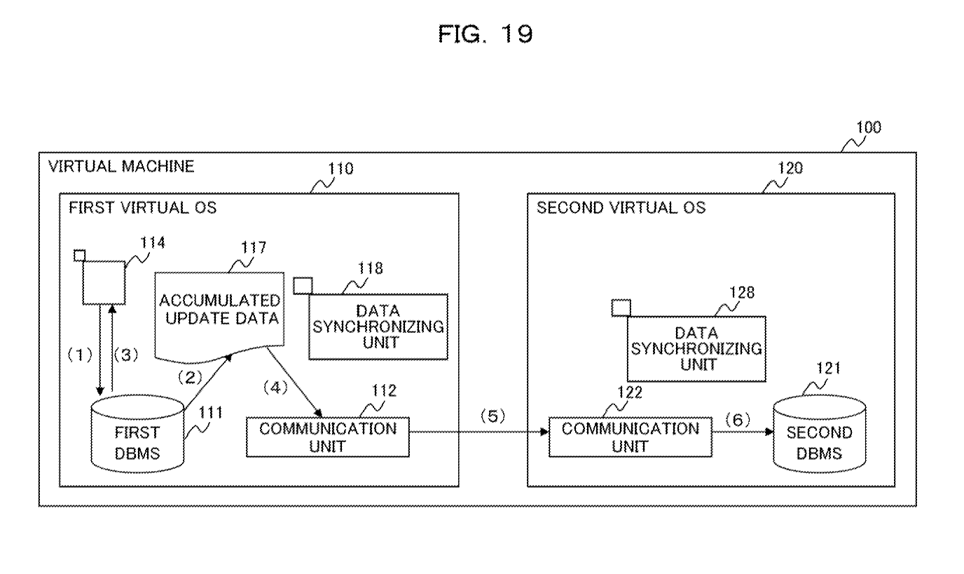

Thus, data synchronization can be performed an the first DBMS 11 and the second DBMS 21, that is, databases of two or more different types through a single lock management mechanism. Further, since data synchronization in the present embodiment can be performed through a shared memory, a risk of a data leak can be drastically reduced compared to data synchronization via a network described with reference to FIG. 18 and FIG. 19.

Further, as described above, since data synchronization in the present embodiment can be performed through a shared memory, for example, even when a network is temporarily unusable, there is no influence of a failure or a delay related to a network, and data synchronization can be reliably performed between a plurality of databases.

In addition, automatic synchronization (updating) of the update data 41 can be performed in real time between the first DBMS 11 and the second DBMS 21, that is, between databases of two or more different types. Thus, as data synchronization is performed through a shared memory, a time lag between databases associated with reflection of the update data 41 can be drastically reduced compared to data synchronization via network described above with reference to FIGS. 18 and 19.

### [2] Others

The exemplary embodiment of the present invention has been described above, but the present invention is not limited to the above embodiment, and various modifications or changes can be made within the scope, not departing from the gist of the present invention.

For example, in the present embodiment, the virtual machine 1 is configured to include the shared memory 40, and the first virtual OS 10 and the second virtual OS 20 that can access the shared memory 40, but the present invention is not limited to this example. For example, an information processing system (system) configured with one or more information processing apparatus (apparatus) may be configured to include a shared memory 40, and a plurality of OSs that can access the shared memory 40.

Further, the present embodiment has been described in connection with data synchronization between two databases, that is, between the first DBMS 11 and the second DBMS 21, but the present invention is not limited to this example. For example, when three or more DBMSs are arranged as the data synchronization target, the data conversion processing unit 31 may perform conversion or update data for the update process for each database of the data synchronization target other than a DBMS on which the update process is performed. Further, locking of the lock range for the update process of the data synchronization target may be performed on all DBMSs of the data synchronization target through the lock control processing unit 33. Furthermore, updating of the DBMS may be performed such that the lock control processing unit 33 updates each of all databases of the data synchronization target using update data or converted update data.

In addition, the process of step S2 illustrated in FIG. 9 may be executed in the process of step S41 illustrated in FIG. 12. In other words, the data update unit 12 may omit generating the update difference data in step S2 illustrated in FIG. 9 but output the pre-update data instead of outputting the update difference data in step S3. At this time, in step S17 illustrated in FIG. 10, the update, data control unit 30 may activate the lock granularity determination processing unit 32 based on the pre-update data and the updated data 41-1 instead of the update difference data. Further, in step S41 illustrated in FIG. 12, the lock granularity determination processing unit 32 may receive the ore-update data and the updated data 41-1 as input data and generate the update difference, data based on the pre-update data and the updated data 41-1.

Note that, a program (data synchronization program) for implementing tee functions of the data update units 12 and 22, the asynchronous reflecting unit 13 and 23, the update data control unit 30, the data conversion processing unit 31, the lock granularity determination processing unit 32, and the lock control processing unit 33 are provided in the form in which the program is recorded in a computer readable recording medium such as a flexible disk, a CD (CD-ROM, CD-R, CD-RW, or the like), a DVD (DVD-ROM, DVD-RAM, DVD-R, DVD+R, DVD-RW, DVD+RW, HD DVD, or the like), a Blu-ray disc, a magnetic disc, an optical disc, or a magneto-optic disc. Further, a computer reads the program from the recording medium, transfers the program to be stored in an internal storage device or an external storage device, and than uses the program. For example, the program may be recorded in a storage device (recording medium) such as a magnetic disc, an optical disc, or a magneto optical disc and then provided from the storage device to a computer via a communication line.

In order to implement the functions of the data update unit 12 and 22, the asynchronous reflecting unit 13 and 23, the update data control unit 30, the data conversion processing unit 31, the lock granularity determination processing unit 32, and the lock control processing unit 33, the program stored in the internal storage device (in the present embodiment, an I/O device such as a memory or a HDD installed in the information processing apparatus or the information processing system) is executed by a microprocessor (in the present embodiment, a CPU installed in the information processing apparatus or the information processing system) of the computer. At this time, the program recorded in the recording medium may be read and then executed by the computer.

Note that, in the present embodiment, the computer is a concept including hardware and an operating system and represents hardware operating under control of the operating system. Further, when an operating system is unnecessary and an application program independently operates hardware, the hardware itself corresponds to the computer. The hardware includes a microprocessor such as a CPU and a device that reads a computer program recorded in a recording medium, and in the present embodiment, the information processing apparatus and the information or system include a function of a computer.

According to the technology of the present disclosure, it is possible to easily convert data to be synchronized between databases when data synchronization is performed between databases of different types.

Further, it is possible to suppress influence of a database lock on an application when data synchronization is performed between databases of different types.

Further, it is possible to reduce a risk of a data leak when data synchronization is performed between databases of different types.

Furthermore, it is possible to reduce a time lag between databases when data synchronization is performed between databases of different types.

All examples and conditional language provided herein are intended for the pedagogical purposes of aiding the reader is in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations cold be made hereto without departing from the spirit and scope of the invention.

What is claimed is:

1. A data synchronization method, comprising:
acquiring first update data for an update process performed on a first database;
converting the first update data into second update data according to a format of a second database based on previously set conversion definition information;
deciding a lock range based on the first update data and pre-update data that has not been subjected to the update process;
locking the first and second databases based on the decided lock range; and
updating the first and second databases using the first and second update data, respectively.

2. The data synchronization method according to claim 1,
wherein the locking of the first and second databases includes
determining whether or not the lock range in the first and second databases has been locked based on lock management information to which lock statuses of the first and second databases are set based on the lock range, and
when it is determined that the lock range has not been locked, setting lock acquisition information representing that the lock range for the update process has been locked in the lock management information.

3. The data synchronization method according to claim 2,
wherein the locking of the first and second databases includes
when it is determined that the lock range has been locked, setting standby information representing that the lock range for the update process is in a lock standby status in the lock management information.

4. The data synchronization method according to claim 3,
wherein the lock management information includes a lock key which is used to specify a row for the update process and common to the first and second databases,
the converting of the first update data into the second update data includes generating a lock key for the update process, and
the determining of whether or not the lock range has been locked includes determining whether or not the same lock key as the generated lock key for the update process is included in the lock management information, and determining that the lock range has not been locked when it is determined that the lock key for the update process is not included in the lock management information.

5. The data synchronization method according to claim 4,
wherein the determining of whether or not the lock range has been locked includes determining whether or not there is a range common to a lock range corresponding to the lock key included in the lock management information and the lock range for the update process when it is determined that the lock key for the update process is included in the lock management information, determining that the lock range has not been locked when it is determined that there is no common range, and determining that the lock range has been locked when it is determined that there is a common range.

6. The data synchronization method according to claim 4,
wherein the first database and the second database are databases of types different from each other, and
the locking of the first and second databases includes referring to the lock management information based on information representing each of a correspondence relation between a lock key of the first database and a lock key of the second database and a correspondence relation between the lock range of the first update data and the lock range of the second update data.

7. The data synchronization method according to claim 3, further comprising:
releasing the locking of the first and second databases after the first and second databases are updated;
determining whether or not the lock range for the update process to which the standby information is set has been locked after releasing the locking; and
when it is determined that the lock range has not been locked, deleting the standby information for the update process from the lock management information, and setting lock acquisition information for the update process to the lock management information.

8. The data synchronization method according to claim 1,
wherein the deciding of the lock range includes deciding the lock range using a column of a table in the first and second databases as a minimum unit.

9. The data synchronization method according to claim 1,
wherein the deciding of the lock range includes
generating update difference data based on the pre-update data and the update data, and
determining a range to be updated by the update process based on the update difference data and deciding the lock range.

10. The data synchronization method according to claim 1,
wherein the converting of the first update data is performed for each data synchronization target database on which the update process is to be performed other than the first database based on the conversion definition information,
the locking of the database includes locking all data synchronization target databases, and
the updating of the database includes updating each of all data synchronisation target databases using the first update data or the converted update data.

11. The data synchronization method according to claim 1,
wherein the converting of the first update data into the second update data and the deciding of the lock range are performed in parallel, and the locking of the first and second databases is performed after the converting of the first update data into the second update data and the deciding of the lock tease are completed.

12. The data synchronization method according to claim 1,
wherein the first database is disposed in a first operating system (OS),
the second database is disposed in a second OS,
the first and second OSs operate on a single system, and
the updating of the first and second databases includes outputting the second update data to the second OS through a shared memory accessible from the first and second OSs.

13. The data synchronization method according to claim 12,
wherein the first and second OSs are virtual OSs, and
the system is a virtual machine.

14. A computer readable recording medium having stored therein a data synchronization program causing a computer to execute a process for synchronizing data, the process comprising:
acquiring first update data for an update process performed on a first database;
converting the first update data into second update data according to a format of a second database based on previously sat conversion definition information;
deciding a lock range based on the first update data and pre-update data that has not been subjected to the update process;
locking the first and second databases based on the decided lock range; and
updating the first and second databases using the first and second update data, respectively.

15. The computer readable recording medium having stored therein the data synchronisation program according to claim 14,
wherein the locking of the first and second databases includes
determining whether or not the lock range in the first and second databases has been locked based on lock management information to which lock statuses of the first and second databases are set based on the lock range, and
when it is determined that the lock range has not been locked, setting lock acquisition information representing that the lock range for the update process has been locked in the lock management information.

16. The computer readable recording medium having stored therein the data synchronization program according to claim 15,
wherein the locking of the first and second databases includes
when it is determined that the lock range has been locked, setting standby information representing that the lock range for the update process is in a lock standby status in the lock management information.

17. The computer readable recording medium having stored therein the data synchronisation program according to claim 16,
wherein the lock management information includes a lock key which is used to specify a row for the update process and common to the first and second databases,
the converting of the first update data into the second update data includes generating a lock key for the update process, and
the determining of whether or not the lock range has been locked includes determining whether or not the same lock key as the generated lock key for the update process is included in the lock management information, and determining that the lock range has not been locked when it is determined that the lock key for the update process is not included in the lock management information.

18. The computer readable recording medium having stored therein the data synchronization program according to claim 16, the process further comprising:
releasing the locking of the first and second databases after the first and second databases are updated;
determining whether or not the lock range for the update process to which the standby information is set has been locked after releasing the locking; and
when it is determined that the lock range has not been locked, deleting the standby information for the update process from the lock management information, and setting lock acquisition information for the update process in the lock management information.

19. The computer readable recording medium having stored therein the data synchronization program according to claim 14,
wherein the deciding of the lock range includes deciding the lock range using a column of a table in the first and second databases as a minimum unit.

20. A data synchronisation control device, comprising:
to processor,
wherein the processor
acquires first update data for an update process performed on a first database,
converts the first update data into second update data according to a format of a second database based on previously set conversion definition information,
decides a lock range based on the first update data and pre-update data that has not been subjected to the update process,
locks the first and second databases based on the decided lock range, and
updates the first and second databases using the first and second update data, respectively.
